(19) United States
(12) Patent Application Publication
(10) Pub. No.: US 2011/0112866 A1
(43) Pub. Date: May 12, 2011

(54) System And Method For Monetized Electronic Mobile Commerce

(76) Inventor: Lawrence J. Gerrans, El Dorado Hills, CA (US)

(21) Appl. No.: 12/944,302

(22) Filed: Nov. 11, 2010

Related U.S. Application Data
(60) Provisional application No. 61/260,410, filed on Nov. 12, 2009.

(51) Int. Cl. G06Q 30/00; G06Q 50/00; G06Q 10/00

(52) U.S. Cl. 705/3; 705/26.1; 705/2; 705/14.64; 705/14.46

(57) ABSTRACT

A system and method for optimizing mobile commerce relates to delivering user applications and interactive content and tracking systems, along with paid content, to a user mobile appliance at a location-based merchant's place of business. This enables location-based merchants to automate business administrative tasking, commerce transaction management, and customer service while increasing revenue generation on behalf of their enterprise, their clients and/or related third parties. The system may securely authenticate, admit, process, profile, aggregate and archive information inputted directly by the client at the merchant's place of business, or in advance of the client's arrival to the merchant's place of business.

### CROSS-REFERENCE TO RELATED APPLICATIONS

The present application claims the benefit under 35 U.S.C. §119 (e) of the U.S. Provisional Patent Application Ser. No. 61/260,410 filed on Nov. 12, 2009, the content of which is incorporated herein by reference in its entirety.

### FIELD OF THE INVENTION

The present teachings relate generally to mobile electronic commerce and, more particularly, to systems and methods for location-based merchants to securely enable and integrate electronic systems in order to optimize their business administrative processes, commerce transactions, and customer service processes, as well as to monetize these systems.

### BACKGROUND OF THE INVENTION

The Internet has provided better information, better education and greater convenience for clients. Internet-enabled cellular phones, lap tops and mobile appliances of the like, have taken the Internet mobile. As such, mobile electronic commerce has grown in popularity. Clients are now accustomed to the immediacy of content delivery via Internet searches, whether at home or on the road. Many Internet applications allow a client to compare manufacturers, products, services and prices. These Internet applications offer product education, services and promotions that broaden a client's understanding of their purchase, improving the client's decision making process and expediting their purchasing decision.

Client experience and satisfaction with traditional location-based merchants, whose primary places of business are physical locations—such as Stores, Offices, Clinics, Hospitals, Restaurants, etc.—is eroding. Many location-based merchants do not have the hardware, software or communications infrastructure to match the purchasing decision-making tools that electronic Internet search and commerce affords clients. However, one of the primary advantages that location-based merchants possess versus Internet-based merchants is sensory stimulus. At a location-based merchant a client can touch, see and feel the merchandise. In addition, location-based merchants provide the instant gratification many clients desire, in the forms of immediacy of product delivery and specialized services. Even so, many location-based merchants lack the interactive education and product discovery experience of the Internet. As a result, many clients conduct their product discovery and pricing search on the Internet in advance of their arrival at a location-based merchant. Many discriminating clients then set out to a location-based merchant to simply gain the sensory stimulus of product evaluation that the location-based merchant provides in the product selection process. Thereafter, the client makes their product purchase on the Internet, strictly according to price. Consequently, the location-based merchant helps facilitate the client's product discovery but loses the opportunity to gain the sale if their price is not competitive with Internet-based merchants.

Many merchants have sought to build Internet- and media-based storefronts that allow them to extend their brand equity beyond their physical storefront to better attract, retain and/or compete for customers. However, these initiatives can be costly to the merchant, compounding the operating costs related to their existing location-based overhead and adversely affecting their profits. It is widely recognized by those experienced in the art of retail merchandising that location-based merchants have significantly higher overhead costs than Internet-based merchants, affecting the price competitiveness of location-based merchants versus Internet-based merchants.

In many instances, location-based merchants provide services that must be performed at their specific locations, such as restaurants, health care practices, automotive service locations, grocery stores, shopping malls, etc. In these environments the customers' satisfaction with their shopping experience will often lead to the merchant's sale of goods and/or services to the consumers. Customer satisfaction is rooted in convenience of product/service search and accessibility, availability of product/service, education and knowledge about a product/service, expedited purchasing of the product/service and price. Location-based merchants often satisfy the physical aspects of customer satisfaction, convenience of product/service search and accessibility, and availability of product/service. However, location-based merchant's lack of electronic commerce infrastructure and media based tools preclude them from satisfying a client's satisfaction with their education, knowledge and understanding about a product/service and/or the competitiveness of the merchant's prices, warranties and/or service and other variables related to the purchasing discovery process.

In many instances, location-based merchants provide products or services that require the client to participate with or in the product or service process being provided. In these environments the client must remain at the merchant's place of business to acquire the product or service, wherein the client's time spent waiting can become long. Clients in these circumstances become bored and frustrated, negatively affecting the client's experience. Location-based merchants spend significant sums on their storefronts, waiting rooms and interactive content (e.g., Magazines, Television, Shuttle Services, etc.) to improve their store's appeal and customer satisfaction with the waiting process. However, these environments are becoming antiquated. They no longer satisfactorily provide services or materials that occupy a client's attention, help the client productively manage their time spent waiting, provide the ability for the client to monitor their waiting time or provide logistical assistance to better enable the client to find their way around a merchant's place of business.

A specific example relates to a patient waiting in the Health Care setting. Hospitals, Clinics and Medical Offices are strewn with bored, frustrated patients trying to find their way about a facility or reading antiquated periodicals in a waiting room in relative silence and in the company of sick strangers. The Centers for Disease Control reported that there were 1.2 billion patient visits made to healthcare providers in 2005. According to research conducted by Alan B. Krueger PhD, an economist at Princeton University, “Americans age 15 and older collectively spent 847 million hours waiting for medical services to be provided in 2007”. Professor Krueger went on to calculate that “If we value all people's time at the average hourly wage of production and nonsupervisory workers ($17.43 in 2007), Americans spent the equivalent of $240 billion on health care in 2007.”

Hospitals, Urgent Care Centers, Clinics, Doctors offices, and Dentists are plagued with increasing patient loads and declining compensation for their services. Ailing Patients and their loved ones are plagued with increasingly long waits in the company of strangers and in relative silence. The health care industry has begun to employ electronic medical records to facilitate electronic reporting and claims processing to create better efficiencies within their patient records systems. The current solutions in health care electronic medical records, however, are focused on “back end” business processes to better facilitate the reporting of patient records and the accounting of health care-related claims and billing.

Currently, electronic medical records systems and related health information technologies are deficient in providing comprehensive solutions for the “front end” people processes of health care that also address the integration between the “front end” people processes and the “back end” business processes of the health care delivery system. There is a bottleneck in the electronic business and service processes of the health care delivery system that is also applicable to many location-based merchants. Moreover, the health care delivery system is plagued with staffing requirements that have employees performing redundant tasking in the forms of data input, records management, patient education, and patient escort. Upon a customer's arrival to a provider's facility or the location-based merchant's place of business, these entities lack the resources, systems and methods to electronically profile and process their customer, educate their customer, navigate their customer around their facility, entertain or pacify their customers while waiting, manage their customers time spent waiting or expedite their customer's service.

In the health care example, when a patient arrives at the provider's facility, or is re-directed to another location in the provider's facility, the patient must first find the provider's office. This can be a daunting task on a large medical campus or medical office complex, which leads to patients becoming lost and inevitably late for their appointment. Upon the patient's arrival to the medical provider's office they are given a clipboard and asked to complete the patient intake questionnaires, financial responsibility, privacy, confidentiality and related business forms. Upon completion of these forms the patient returns the clipboard to a secretary and then returns to his or her seat in the waiting room to sit in relative silence with few available resources, such as magazines or a television on a wall, to pacify their time spent waiting. The secretary is then tasked with reviewing the patient intake forms for completeness and manually inputting the data the patient has provided on the forms into the provider's electronic records system. This is a redundant, labor-intensive, time consuming “front office” process that delays the client's/patient's records processing to the “back office”.

Consequently, the provider bears increased manpower costs and loses time efficiency performing a task that, if automated, the patient could have completed themselves. Moreover, as a result, the client/patient bears increased waiting times and a loss in their productivity. In addition, the medical provider's inability to provide electronic commerce infrastructure and media-based tools wastes its valuable time and manpower resources. It is also an opportunity lost on the part of the provider and the client/patient relative to the client's/patient's understanding of the problems/issues at hand and possible solutions/remedies available. Accordingly, there is also opportunity lost to the provider and the client/patient in affording the client/patient better service by providing vehicles that assist the client/patient in finding their way about the provider's facility and/or allowing them a vehicle to monitor the remaining time they must wait for services. There is also opportunity lost in providing vehicles that entertain and pacify the client/patient while they wait at the provider's place of business. Last, there is opportunity lost to the provider in not employing applications or vehicles that monetize the client's/patient's time spent waiting for services at their place of business.

In summary, the current problems facing location-based merchants such as health care providers and retail merchants are the lack of comprehensive electronic applications and resources to: securely authenticate and/or admit or process a client upon arrival to their place of business; capture relevant information specific to the client and their profile; archive a client's information/profile in a secure database; provide the client applications, vehicles and/or interfaces that allow the client remote electronic access to the clients records; provide applications, vehicles and/or interfaces that educate the client on relevant information while the client waits at their place of business; provide applications, vehicles and/or interfaces that assist the client/patient in finding their way about the providers facility and/or allow them a vehicle to monitor the remaining time they must wait for services; provide applications, vehicles and/or interfaces that entertain the client while they wait at the providers place of business; employ interactive applications, vehicles and/or interfaces that monetize the client's time spent waiting for services at their place of business; and provide remote applications, vehicles and/or interfaces that allow the client to electronically interact with the location-based merchant remotely.

Providing the resources, systems and methods that create the comprehensive solution to overcome these problems is oftentimes costly and can become a burden to the operating costs of a location-based merchant. Location-based merchants view customer service as a cost of doing business. There are no systems or methods available to location-based merchants that optimize the customer service experience and that also optimize the efficiency of their operations and generate revenue for the merchant. Many location-based merchants are aware that their customer base fits specific profiles that are of value to other merchants. In many cases merchants sell and trade customer lists with other merchants or marketing lead generation services for nominal compensation. The Internet has made the practice of client profiling an efficient and profitable science. Search Engines such as Google and Yahoo have expertise in profiling clients while they browse online. These search engines provide the service of profiling clients and matching client targets with advertisers and marketers for a fee. Internet-based merchants have also become expert at profiling and tracking their customers to generate repeat sales and/or leads that they can sell to other advertisers, marketers and merchants.

Location-based merchants need to optimize their business services to match those of their counterparts on the Internet while still reducing their overhead costs and improving their price competitiveness. If provided with the optimal electronic business systems and methods, location-based merchants could supplement their rising overhead and customer service costs. Providing their customers with service applications that run on an electronic mobile appliance, or applications that run on the customer's own mobile appliance, that offer automated services, logistics and tracking, education and/or entertainment that provides paid content and that generates revenue for the merchant and/or the client would resolve many of the disadvantages location-based merchants face. Advertisers and marketers could very well pay more for lead generation from a merchant with a unique clientele that matches their target market. Clients would, in most cases, be more inclined to view and act upon advertising content if they knew they were to be compensated and/or their merchant was to be compensated for their participation in viewing paid content. Compensation could come in the forms of currency, credit, affinity, points, tokens or any other form of credit or stored value.

What is needed is a comprehensive system and method that electronically optimizes a merchant's front office administration and customer service, integrates and communicates with its back office operations and provides a revenue stream to the merchant and/or client throughout the process. Such a comprehensive system and method is not available. What is needed is to provide an application and interface to better authenticate, admit, process and profile the customer, archive the customer's data in a secure database that can be remotely accessed by the customer and the provider, educate the customer on relevant information, assist the customer's logistical needs, entertain and pacify the customer while waiting at the provider's place of business, provide an interactive communications forum from which a client or provider may socially network with one another and/or their peers regarding the merchant's products or services, and that generates revenues for the merchant and/or client while the client waits at the merchant's place of business. Other drawbacks exist in known environments, processes and systems.

### SUMMARY OF THE INVENTION

The needs set forth herein as well as further and other needs and advantages are addressed by the present embodiments, which illustrate solutions and advantages described below.

One objective of the present teachings is to provide optimized electronic mobile commerce systems and methods that better allow the merchant to securely authenticate, admit, process, profile, capture and archive information inputted directly by the client at the merchant's physical or virtual place of business, or in advance of the client's arrival to the merchant's place of business, and that expedites the merchant's administrative and data processing, authenticates the customer's identification, facilitates relevant and/or requisite documentation processing, streamlines commerce transaction management, accounts payable and receivable, assists the client's logistical requirements in locating products and/or services, allows the client to monitor relevant waiting times for products or services to be delivered, provides the client with educational tools and interactive information, provides the client with entertainment and interactive activities to pacify the client while waiting, integrates the front end office applications with the merchant's back end operational systems to expedite service and generates revenues on behalf of the merchant and/or client and/or third party derived from the client's viewing and interaction with paid content concurrent to their viewing and interaction with the business administration processing, commerce transaction and/or customer service content described.

It is a further object of the present teachings to provide systems and methods that operate on mobile appliances such as cellular telephones, Tablet PC's, Lap Tops and/or related mobile appliances that access mobile communication networks and infrastructure.

It is a further object of the present teachings to provide systems and methods that operate over wireless communications infrastructure accessed by said mobile appliances such as cellular telephones, Tablet PC's, Lap Tops and/or related mobile appliances that access mobile communication networks and infrastructure.

It is yet another object of the present teachings to provide systems and methods that stream paid content (e.g., visual, audio, etc.) on, around, underlying and/or within the user's content and/or interface and that generates revenue in the forms of currency, affinity, tokens, points, credits, rewards and/or stored values that are redeemable by the merchant and/or the client and/or third party in any of the said forms, although not limited thereto.

It is yet another object of the present teachings to provide systems and methods that stream paid audio content that accompanies said paid visual content on, around, underlying and/or within with the user's content and/or interface and that generates revenue in the forms of currency, affinity, tokens, points, credits, rewards and/or stored values that are redeemable by the merchant and/or the client and/or third party in any of the said forms.

It is yet another object of the present teachings to provide systems and methods that stream paid audio content in concert with the user's content and/or interface and that generates revenue in the forms of currency, affinity, tokens, points, credits, rewards and/or stored values that are redeemable by the merchant and/or the client and/or third party in any of the said forms.

It is still another object of the present teachings to provide systems and methods that authenticate the user using one or any plurality of the following: User Name; Password; Code; Biometric identifier—such as a finger print, palm print, retina, voice, hair, etc; electronic signature; and/or electronic appliance identification number.

It is yet another object of the present teachings to provide systems and methods that provide a menu of products and/or services and the associated costs of those products and/or services to the user to encourage upsells, cross-sells and other forms of marketing, although not limited thereto.

It is another object of the present teachings to provide systems and methods that provide electronic commerce interfaces and monetary exchanges that allow the user to order and purchase said products or services.

It is another object of the present teachings to provide systems and methods that provide electronic interfaces with financial, credit and/or banking institutions.

It is another object of the present teachings to provide systems and methods that provide electronic interfaces with third party users, suppliers, retailers, administrators and/or merchants.

It is another object of the present teachings to provide systems and methods that provide rules interfaces that govern access, authentications, authorizations, transactions, communications, content, navigation and logic.

It is another object of the present teachings to provide systems and methods that provide navigation and/or tracking tools, applications and/or interfaces.

It is another object of the present teachings to provide systems and methods that provide translator and communications logic tools, applications and/or interfaces.

It is another object of the present teachings to provide systems and methods that provide integration brokerage tools, applications and/or interfaces.

It is another object of the present teachings to provide systems and methods that provide commerce engines and commerce related tools, applications and/or interfaces.

It is another object of the present teachings to provide systems and methods that provide stored value accounts and/or stored value-related tools, applications and/or interfaces.

It is another object of the present teachings to provide systems and methods that provide system logic, optimization and redundancy.

It is another object of the present teachings to provide systems and methods that provide transaction management engines, tools, applications and/or interfaces.

It is another object of the present teachings to provide systems and methods that provide paid content and/or paid content tools, applications and/or interfaces.

It is another object of the present teachings to provide systems and methods that provide content search and/or content search-related tools, applications and/or interfaces.

It is another object of the present teachings to provide systems and methods that provide electronic interfaces with financial, credit and/or banking institutions.

It is another object of the present teachings to provide systems and methods that provide marketplaces and/or marketplace-related tools, applications and/or interfaces to facilitate commerce.

It is another object of the present teachings to provide systems and methods that provide affinity and/or affinity related tools, applications and/or interfaces to aggregate and redeem affinity and related stored values.

It is another object of the present teachings to provide systems and methods that provide revenue generation tools, applications and interfaces on behalf of the merchant, client and/or third party.

It is another object of the present teachings to provide systems and methods that provide system and user administration tools, applications and interfaces.

It is another object of the present teachings to provide systems and methods that provide system and user education tools, applications and interfaces.

It is another object of the present teachings to provide systems and methods that provide system and user entertainment and/or interactive content tools, applications and interfaces.

It is another object of the present teachings to provide systems and methods that provide a plurality of system and user-specific databases.

It is still another object of the present teachings to provide systems and methods that provide electronic commerce tools, applications and/or interfaces that track the user's activities and/or bank the user's earned revenues in a currency and/or stored value repository for monetary exchange or other redemption.

It is a further object of the present teachings to provide systems and methods for admitting, recognizing and/or processing a user.

It is still another object of the present teachings to provide systems and methods that allow the user to set up, establish, access, input and edit information specific to the user's profile and/or records.

It is another object of the present teachings to provide systems and methods that allow an authenticated and permitted third party user to access, input and/or edit information and/or documents specific to a designated user's profile and/or records.

It is yet another object of the present teachings to provide systems and methods that authenticate and permit said third party to access a designated users profile and/or records.

It is still another object of the present teachings to provide systems and methods that govern and track said authenticated and permitted third party user's access and privileges to review and/or interact with a user's profile and/or records.

It is another object of the present teachings to provide systems and methods that allow the user to archive and track their profile, data, information and documents related to the user's profile and/or account.

It is yet another object of the present teachings to provide systems and methods that allow users to securely communicate with one another individually and/or collectively.

It is another object of the present teachings to provide systems and methods that allow users to determine their eligibility for receiving and/or providing credit, products and/or services.

It is still another object of the present teachings to provide systems and methods that allow authenticated and permitted users and/or third party administrators to determine the eligibility of a designated user for receiving and/or providing credit, products and/or services.

It is another object of the present teachings to provide systems and methods that provide paid content along with educational tools and/or interactive information and content to the user on the products and/or services they are evaluating, investigating, ordering and/or purchasing and that allow the user to share in the revenues derived from the paid content they view during the interaction.

It is a further object of the present teachings to provide systems and methods that provide paid content along with entertainment and/or interactive information and content to the user while they wait for products and/or services to be rendered, ordered, purchased and/or delivered and that allow the user to share in the revenues derived from the paid content they view during the interaction.

It is yet another object of the present teachings to provide systems and methods that integrate the systems, applications and interfaces referenced herein with third party systems, applications and interfaces.

The system of the present embodiment includes, but is not limited to: a provider server having information related to products and/or services of the location-based business, the provider server accessible over a network from the location-based business; management software executing on a computer readable medium for managing the information in the provider server by an agent of the location-based business; authentication software executing on a computer readable medium for authenticating the mobile device based at least in part on the proximity of the mobile device to the geographic location of the location-based business; and mobile interface software executing on a computer readable medium for providing the information from the provider server to the customer wirelessly through the mobile device and for receiving data input from the customer through the mobile device. The provider server communicates over a network with a business server which is located at the location-based business and has information related to back-office operations of the location-based business, including customer information for the customer. When the customer is at or near the geographic location of the location-based business the customer is provided access to relevant information on the provider server through the mobile device, the relevancy of the provided information determined at least in part by the customer information. The customer may complete a task related to a visit to the location-based business and information about the task is communicated from the provider server to the business server.

The system of the present embodiment also includes, but is not limited to: a provider server having information related to products and/or services of the location-based business, the provider server accessible over a network from the location-based business; management software executing on a computer readable medium for managing the information on the provider server by an agent of the location-based business; authentication software executing on a computer readable medium for authenticating the mobile device based at least in part on the proximity of the mobile device to the location-based business; mobile interface software executing on a computer readable medium for providing the information from the provider server to the customer wirelessly through the mobile device and for receiving data input from the customer through the mobile device; administration software executing on a computer readable medium for alerting the location-based business to the customer's presence and/or providing the customer a time estimate until the customer will be helped by an agent of the location-based business and/or providing information about the customer; education software executing on a computer readable medium for providing, through the mobile device, educational information related to the location-based business' products and/or services; and advertising software executing on a computer readable medium for providing directed advertising to the customer, through the mobile device, based at least on the type of location-based business and/or the information the customer is viewing through the mobile device. The provider server communicates over a network with a business server, which is located at the location-based business and has information related to back-office operations of the location-based business including customer information for the customer. When the customer is at or near the geographic location of the location-based business the customer is provided access to relevant information on the provider server through the mobile device, the provided relevant information relevant at least in part by the customer information. The customer may complete a task related to a visit to the location-based business, and information about the task is communicated from the provider server to the business server.

The system of the present embodiment also includes, but is not limited to: a provider server having information related to products and/or services of the medical provider, the provider server accessible over a network from the medical provider; management software executing on a computer readable medium for managing the information on the provider server by an agent of the medical provider; authentication software executing on a computer readable medium for authenticating the mobile device based at least in part on the proximity of the mobile device to the medical provider; mobile interface software executing on a computer readable medium for providing the information from the provider server to the patient through the mobile device and for receiving data input from the patient wirelessly through the mobile device; administration software executing on a computer readable medium for alerting the location-based business to the patient's presence at the geographic location of the medical provider and/or providing the patient a time estimate until the patient will be seen by the medical provider; education software executing on a computer readable medium for providing, through the mobile device, educational information related to the patient's visit to the medical provider; and advertising software executing on a computer readable medium for providing directed advertising to the patient, through the mobile device, based at least on the type of medical provider and/or the information the patient is viewing through the mobile device and/or information about the patient. The provider server communicates over a network with a business server, the business server located at the medical provider and having information related to back-office operations of the medical provider including patient information about the patient. When the patient is at or near the geographic location of the medical provider the patient is provided access to information on the provider server through the mobile device. The patient may complete a task related to a visit to the medical provider, and information about the task is communicated from the provider server to the business server.

The system of the present embodiment also includes, but is not limited to: a provider server having information related to the goods and/or services of the location-based business, the provider server accessible over a network from the location-based business; management software executing on a computer readable medium for managing the information on the provider server by an agent of the medical provider; authentication software executing on a computer readable medium for authenticating a mobile device based at least in part on the proximity of the mobile device to the medical provider; mobile interface software executing on a computer readable medium for providing the information from the provider server to a customer of the location-based business through the mobile device and for receiving data input from the customer wirelessly through the mobile device; and a business server having information related to back-office operations of the location-based business including customer information for the customer, the business server located at the location-based business and adapted to communicate with the provider server. The customer may complete a task related to a visit to the location-based business through the mobile device, and information about the task is communicated from the provider server to the business server.

The method of the present embodiment includes the steps, but is not limited to: providing a provider server having information related to the goods and/or services of the location-based business, the provider server accessible over a network from the location-based business; providing management software executing on a computer readable medium for managing the information on the provider server by an agent of the medical provider; providing authentication software executing on a computer readable medium for authenticating a mobile device based at least in part on the proximity of the mobile device to the medical provider; providing mobile interface software executing on a computer readable medium for providing the information from the provider server to a customer of the location-based business through the mobile device and for receiving data input from the customer wirelessly through the mobile device; and providing a business server having information related to back-office operations of the location-based business including customer information for the customer, the business server located at the location-based business and adapted to communicate with the provider server. The customer may complete a task related to a visit to the location-based business through the mobile device, and information about the task is communicated from the provider server to the business server.

The system of the present embodiment also includes, but is not limited to: a provider server having information related to products and/or services of the business, the provider server accessible over a network; management software executing on a computer readable medium for managing the information in the provider server by an agent of the business; authentication software executing on a computer readable medium for authenticating the mobile device based at least in part on a username/password combination and/or a biometric identifier; and mobile interface software executing on a computer readable medium for wirelessly providing the information from the provider server to the customer through the mobile device and for receiving data input from the customer through the mobile device. The provider server communicates over a network with a business server, the business server having information related to back-office operations of the business including customer information for the customer. The customer is provided access to information on the provider server through the mobile device, the provided relevant information determined at least in part by the customer information. The customer may complete a task related to a transaction with the business, and information about the task is communicated from the provider server to the business server.

The system of the present embodiment also includes, but is not limited to: a provider server having information related to products and/or services of the location-based business, the provider server accessible over a network from the location-based business; management software executing on a computer readable medium for managing the information in the provider server by an agent of the location-based business; authentication software executing on a computer readable medium for authenticating the mobile device based at least in part on the proximity of the mobile device to the geographic location of the location-based business; mobile interface software executing on a computer readable medium for wirelessly providing the information from the provider server to a customer of the location-based business through the mobile device and for receiving data input from the customer through the mobile device; and advertising software executing on a computer readable medium for providing directed advertising to the customer, through the mobile device, based at least on the type of location-based business and/or the information the customer is viewing through the mobile device and/or information about the customer. The provider server communicates over a network with a business server, the business server located at the location-based business and having information related to back-office operations of the location-based business including customer information for the customer. When the customer is at or near the geographic location of the location-based business the customer is provided access to information on the provider server through the mobile device. The customer may complete a task related to a visit to the location-based business through the mobile device, and information about the task is communicated from the provider server to the business server.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is an exemplary schematic representation of a system for optimizing electronic mobile commerce, according to an embodiment of the present teachings;

FIG. 2 is an exemplary diagram of a system, environment and user interface for optimizing electronic mobile commerce, according to an embodiment of the present teachings;

FIG. 3 is an exemplary diagram of a system, environment and user interface for optimizing electronic mobile commerce, according to an embodiment of the present teachings;

FIG. 4 is an exemplary diagram of a system, environment and user interface for optimizing electronic mobile commerce, according to an embodiment of the present teachings;

FIG. 5 is an exemplary illustration of a user interface and related applications content for optimized electronic mobile commerce, according to an embodiment of the present teachings;

FIG. 6 is an exemplary flowchart showing a method for optimized and interactive processes of an electronic mobile commerce system, according to an embodiment of the present teachings;

FIG. 7 is an exemplary flowchart showing a method for accessing and utilizing an optimized electronic mobile commerce system, according to an embodiment of the present teachings;

FIG. 8 is an exemplary flowchart showing further details of the optimized process of FIG. 7 relating to first time user set up and security authentication processing, according to an embodiment of the present teachings;

FIG. 9 is an exemplary flowchart showing further details of the optimized process of FIG. 7 relating to user authentication and processing, according to an embodiment of the present teachings;

FIG. 10 is an exemplary flowchart showing further details of the optimized process of FIG. 7 relating to the sequential logic and navigation processes, according to an embodiment of the present teachings;

FIG. 11 is an exemplary block diagram showing the process of user interaction with an optimized electronic mobile commerce system and the monetization of that interaction to the benefit of the merchant, according to an embodiment of the present teachings;

FIG. 12 is an exemplary block diagram showing the process of user interaction with an optimized electronic mobile commerce system and the monetization of that interaction to the benefit of both the merchant and the user, according to an embodiment of the present teachings; and

FIG. 13 is a simplified exemplary diagram of the systems depicted in FIGS. 1-5 and which enables the flowcharts depicted in FIGS. 6-12.

### DETAILED DESCRIPTION OF THE INVENTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

Hereinafter, aspects of systems and methods of the present teachings in accordance with various embodiments will be described. As used herein, any term in the singular may be interpreted to be in the plural, and alternatively, any term in the plural may be interpreted to be in the singular.

In order to overcome the deficiencies and disadvantages of current systems and to achieve at least some of the objects and advantages listed, the present teachings comprise a system and method of delivering electronic user applications and interactive user content and tracking along with paid content to a mobile appliance at a merchant's place of business. The present teachings are also intended to generate revenues derived from users viewing said paid content on behalf of the merchant and/or user and/or third party acting on behalf of the merchant or user during their interaction with the user applications and/or interactive user content and/or tracking systems.

In one embodiment, although not limited thereto, the present teachings provide a system and method for a merchant to electronically authenticate a client, verify the client's identity, process the client's admission, profile the client, determine the client's eligibility for certain services and products, provide the client with a menu listing services and products, educate the client on said products and services, entertain the client, accept electronic payments for said products or services purchased by the client, provide the client with a timer to monitor their anticipated waiting times, and provide the client with a location tracking system to escort them to specific locations wherein they can expect to find and/or receive goods and services. This may be accomplished while generating revenue streams for the merchant and/or client derived from paid content viewed by the user during these processes.

In certain advantageous embodiments, the present teachings provide a system and method for a client to electronically authenticate him- or herself, process admission, complete a profile, determine eligibility for certain services and products, view a menu listing services and products, view educational information and interactive content on desired products and/or services, view and/or engage in entertainment and interactive content to pacify time spent waiting, facilitate electronic payments for desired products or services, monitor a timer that provides information on the client's anticipated waiting time, and follow an interactive tracking system that navigates the client to find and/or receive goods and/or services. This may all be accomplished while generating revenue streams for the merchant and/or client derived from paid content viewed by the user during these processes.

In some embodiments, the present teachings provide a system and method for a user to interact with an electronic menu listing services and products, view interactive content and/or educational information related to the menu items, order selected menu items, pay for said selected menu items, view entertainment content and interactive activities to pacify their time spent waiting for their products or services to be delivered, observe a timer to maintain an understanding of how long their wait time is, and follow an interactive tracking system that navigates the client to where they can expect to find and/or receive goods and/or services. This may all be accomplished while generating revenue streams on behalf of the merchant and/or client derived from paid content viewed by the user during these processes.

In certain embodiments, the present teachings provide a system and method for a user to identify a product or service via its product code, whether that product code is an identification number, SKU number, bar code, electronic identifier, radio frequency identifier, light wave identifier, ultrasonic identifier and/or image identifier or some other identifier, view interactive content and/or educational information related to said selected product or service, order said selected product or service, pay for said selected product or service, view entertainment content and/or interactive activities to pacify their time spent waiting for said products or services to be delivered, observe a timer to maintain an understanding of how long their wait time is, and follow an interactive tracking system that navigates the client to where they can expect to find/or receive goods and/or services. This may all be accomplished while generating revenue streams on behalf of the merchant and/or client derived from paid content viewed by the user during these processes.

In certain embodiments, the present teachings provide systems and methods for a user to access their account and/or profile to facilitate commerce and related payment and/or billing transactions from their currency, credit, affinity, token, rewards and/or stored value accounts and/or repositories, although not limited thereto.

In some embodiments, the present teachings provide systems and methods for an authorized third party to access a designated user's account and/or profile to determine the user's eligibility for certain products or service and/or to access, input, edit, upload, download and/or view data, records and information specific to the user's account and/or profile. This may all be accomplished while generating revenue streams on behalf of the user from paid content viewed by the user during these processes.

In certain embodiments, the present teachings provide systems and methods for a user to view paid content along with informational, educational, interactive and/or entertainment content while waiting for products or services to be delivered in order to generate revenues in the forms of currency, credit, rewards, points, tokens, affinity and/or stored values on behalf of the merchant and/or client and/or a selected third party, although not limited thereto.

In some embodiments, the present teachings provide systems and methods for a user to authenticate him- or herself at a kiosk at a merchant's location wherein they are assigned and/or rent (borrow, etc.) the electronic mobile appliance from a docking station and/or checkout stand and thereafter use the mobile appliance to navigate their way about the merchant's facility, find products and/or services, view educational content and/or interactive information related to the merchant's products and/or services, order products and/or services, pay for products and/or services, view entertainment content and/or interactive activities while they wait for products and/or services to be delivered and monitor a timer that provides real time information on the remaining time to be spent waiting for their products or services to be delivered.

The systems and methods of the present teachings are directed to the above stated problems, as well as other problems, that are present in known environments, systems and techniques. The foregoing description of various products, methods, or apparatus and their attendant disadvantages is in no way intended to limit the scope of the present teachings, or to imply that the present teachings do not include some or all of various elements of known products, methods, and/or apparatus in one form or another. Indeed, various embodiments of the present teachings may be capable of overcoming some of the disadvantages noted, while still retaining some or all of the various elements of known products, methods, and apparatus in one form or another.

In one embodiment, the present teachings provide a comprehensive system and method for optimized electronic mobile commerce or the monetization of user-facilitated business administrative processes, commerce transactions and customer service functions, including electronic and other transactions and functions. This may enable a commerce initiator (e.g., client, user, etc.) such as a consumer, business or government entity using an electronic mobile appliance to securely identify himself, authenticate himself, admit himself, process himself, profile himself, schedule a service, manage records, view interactive menus of products or services, educate himself on desired products and/or services, navigate to find or receive products and/or services, order products and/or services, pay for products and/or services, monitor the time spent waiting for said products and/or services to be delivered, entertain himself via media-based entertainment and/or interactive activities to pacify time spent waiting for said products and/or services to be delivered, and to monetize these activities by viewing paid content concurrent to interacting with and/or viewing these business administration processes, commerce transactions and customer service related content to optimize business administration, customer service and revenue generation. The revenue may be generated on his behalf, or on behalf of the merchant and/or a third party, although not limited thereto.

In one regard, the present teachings may permit both the client and merchant the ability to transparently enjoy the benefits of optimization, once business administration processes, commerce transactions and other functions and/or data and records are inputted and facilitated, since the system may automatically arrange for the best available delivery mechanism to satisfy the business administration processes, commerce transactions and records integration. The present teachings may furthermore achieve economies for both the merchant and the client, since business administration processing, commerce transactions and customer service functions may be facilitated and optimized by the client. The present teachings in another regard may increase the range and flexibility of available revenue sources to the benefit of the merchant, the client and a third party, by using an integrated commerce engine that allows each to earn revenue derived from the paid content viewed during the business interaction, although not limited thereto.

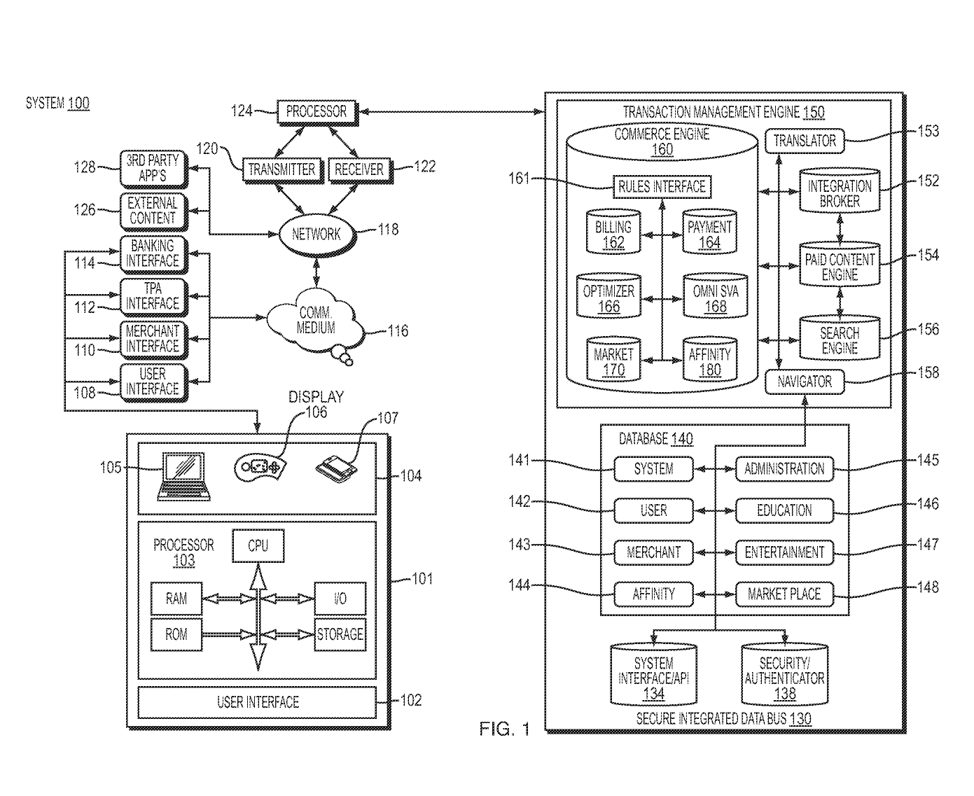

As shown in FIG. 1, the electronic mobile commerce system 100 of the present teachings in one regard may provide a consumer, business or other commerce initiator with an integrated interface with which to autonomously manage and facilitate the business administrative processing, commerce transactions and customer service functions of any number of types of location-based merchants and/or other enterprises. It enables revenue generation on behalf of the client, merchant and/or third party, derived from the commerce initiator's viewing of paid content concurrent to the management and facilitation of business administrative processing, commerce transactions and customer service functions on an optimized basis.

For example, although not limited thereto, using the mobile electronic commerce system 100 of the present teachings the commerce initiator may facilitate electronic, paper or other business administrative processes and customer service functions of, for instance, a medical provider account, a government provider account, a merchant provider account, a restaurant provider account, a grocery provider account, an education provider account, an automotive service provider account, a charitable provider account, a virtual on-line provider accounts or any other commerce provider account through an integrated and relatively streamlined interface. The present teachings in another regard may interface to conventional software packages, such as Electronic Medical Records (EMR's) or others as a front end, to increase ease of use for consumers, businesses and other commerce initiators familiar with those tools.

The commerce initiator (e.g., client, customer, etc.), commerce provider and third party may schedule funds related to the revenues earned from viewing paid content to be deposited into any variety of deposit accounts, such as checking or other demand deposit accounts (DDAs), money market funds, securities accounts, affinity accounts, stored value accounts, other credit card accounts, currency accounts, lines of credit or other accounts or facilities which may act as a funds depository.

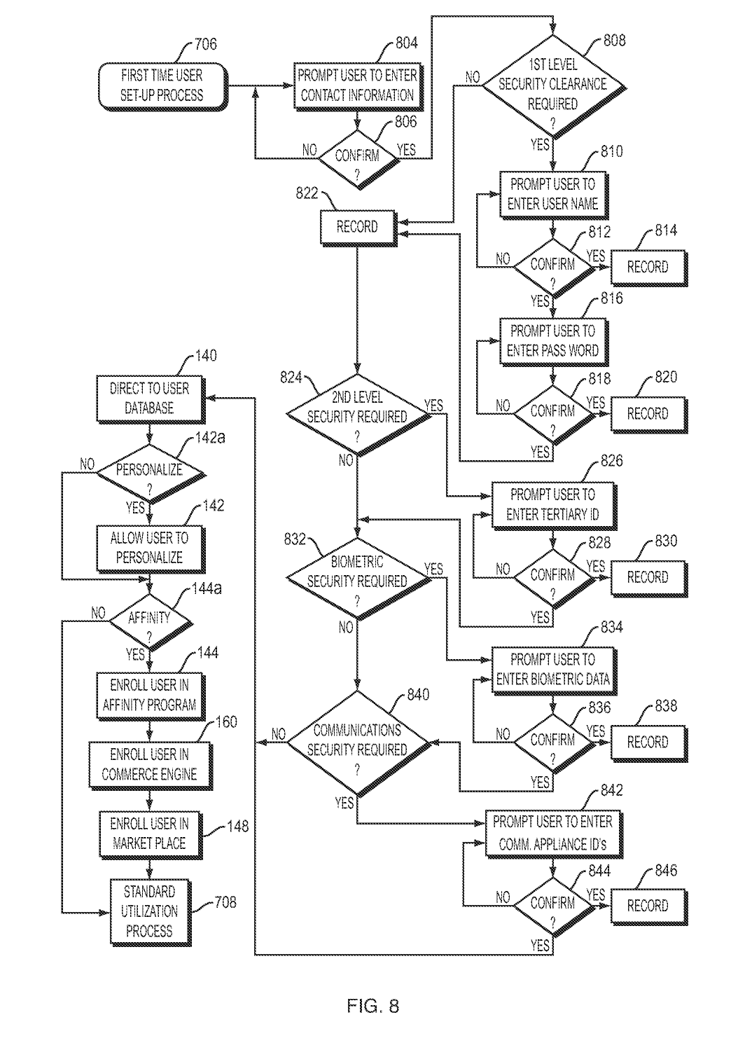

In one embodiment, the mobile electronic commerce system 100 of the present teachings may aggregate, register, profile and/or personalize data and records specific to any type or kind of user content for any type or number of clients, merchants and third parties to be stored in the secured integrated data bus 130, as illustrated in FIG. 8, to effectuate the most optimal community for all constituents to conduct business, facilitate social interaction and collaboratively attract and generate revenue. It will be understood that in practice less or significantly more users and content may be connected or connectable to an electronic mobile commerce system 100.

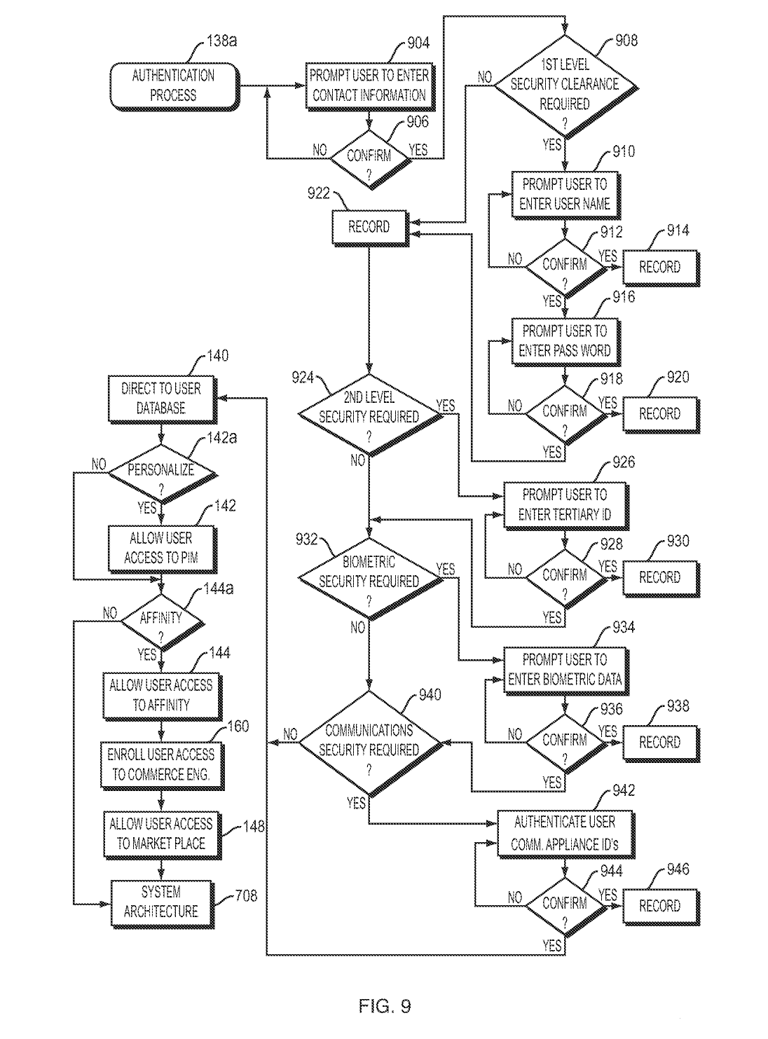

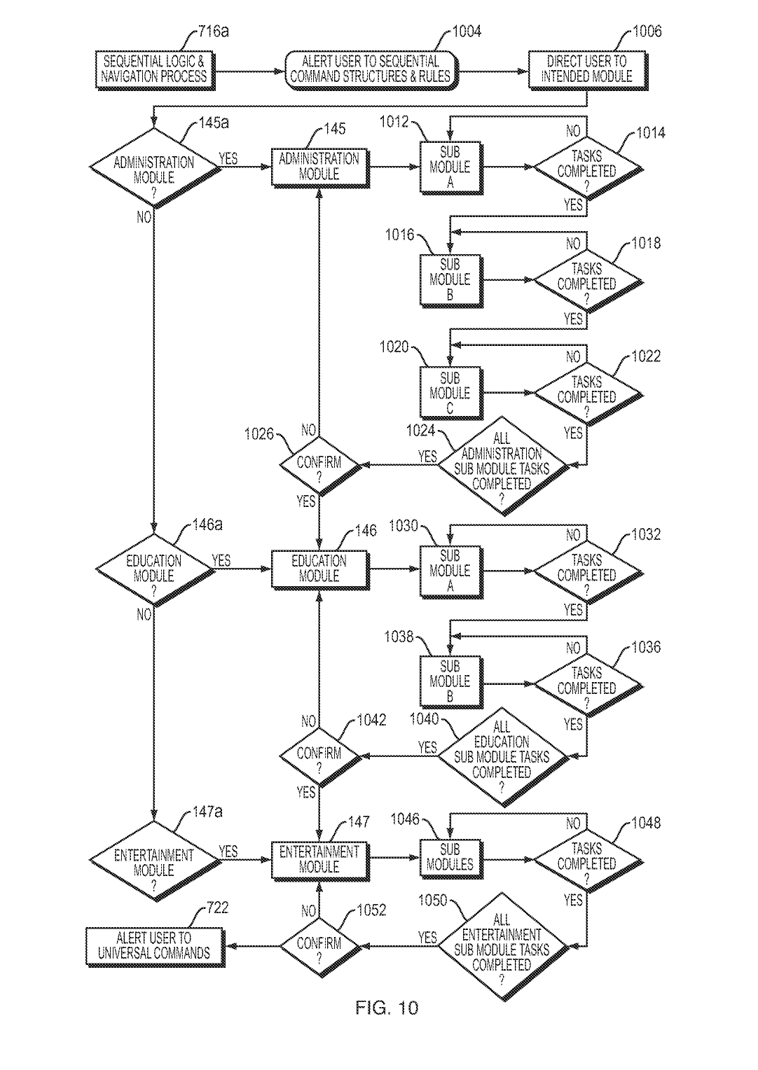

The mobile electronic commerce system 100 of the present teachings may then provide a flexible, one-view interface 134 using a secure authentication process, as illustrated in FIG. 9, and a sequential logic and navigation process, as illustrated in FIG. 10, to all of the possible business administration processes, commerce transactions and customer service functions required to interact with and/or fulfill the business, commerce and customer service activities between the client, merchant and/or third party. The client, merchant and third party may therefore view and manage all their business administration processes, commerce transactions and customer service functions, without resorting to multiple platforms or performing multiple authentications, other than to interact with non-integrated personal financial accounts and/or confidential medical provider accounts.

The mobile electronic commerce system 100 may maintain a designated security & authentication module 138 to verify user identity, the user being a client, merchant or third party. Security of the system may use one or any plurality of the following, although not limited thereto: User Name; Password; Code; Biometric identifier—such as a finger print, palm print, retina, voice, hair, etc; electronic signature; electronic appliance identification number. Security and authentication protocols may be updated randomly to maintain currency of system integrity and security. In this way all parties are assured confidence in the security of access to the system. User identification and security authentication information may be collected during the First Time User Set-Up Process, as illustrated in FIG. 8. Access may thereafter be provided according to the authentication process, as illustrated in FIG. 9. It will be understood that that in practice less or significantly more authentication processes and/or methods may be connected or connectable to an electronic mobile commerce system 100.

The mobile electronic commerce system 100 of the present teachings in another regard may provide multiple interfaces to multiple constituents in order to manage, facilitate and track multiple synergistic relationships. The present teachings may include system interfaces and application provider interfaces 134 to conventional software packages, such as Electronic Medical Records (EMR's) or others as a front end, to increase ease of use for consumers, businesses and other commerce initiators familiar with those tools. Other synergistic interfaces provided by the present teachings may include those specific to various User Interfaces 108, Merchant Interfaces 110, Third Party Administrator Interfaces 112 and Banking and Finance Interfaces 114, although not limited thereto.

In operation, as illustrated in FIG. 1, consumers, businesses, government entities and other commerce initiators may use one or more clients 101 to access the mobile electronic commerce system 100 through a network 118, for instance through multiple communications mediums 118 such as Internet service providers (ISPs) or others.

According to one embodiment of the present teachings, the clients 101 may be or include, for instance, a Personal Computer, Laptop Computer, Tablet PC or any other related computing device running Microsoft Windows™ 9x, Millenium™, NT™, 2000 or XP™, Vista™, 7™, Windows CE™, MacOS™, PalmOS™, Unix, Linux, Solaris™, OS/2™, or some other operating system. Clients 101 may also include a network-enabled appliance such as a WebTV™ unit, radio-enabled Palm™ Pilot or similar unit, a set-top box, a networkable game-playing console such as Sony Play Station™, Sega Dreamcast™ or Microsoft XBox™, a browser-equipped or other network-enabled cellular telephone, an automated teller machine (ATM), an electronic wallet (client side or server side), a TCP/IP client or other device, or a stand-alone Website offering, although not limited thereto. Client 101 may yet further include character recognition platforms or voice recognition platforms or other channels.

The network 118 may include or interface with, although not limited thereto, the Internet, an intranet, a LAN (Local Area Network), a WAN (Wide Area Network) a digital T1, T3, E1 or E3 line, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or other connection. Network 118 may further include any one or more of a WAP (Wireless Application Protocol) link, a GPRS (General Packet Radio Service) link, a GSM (Global System for Mobile Communication) link, a CDMA (Code Division Multiple Access) or TDMA (Time Division Multiple Access) link such as a cellular phone channel, a GPS (Global Positioning System) link, CDPD (cellular digital packet data), a RIM (Research in Motion, Limited) duplex paging type device, a Bluetooth, BlueTeeth or WhiteTooth radio link, or an IEEE 802.11 (Wi-Fi)-based radio frequency link. Network 118 may yet further include or interface any other wired or wireless, digital or analog interface or connection.

Communications Medium 116 may include a provider that connects the requesters to the network 118, although not limited thereto. For example, Communications Medium 116 may include an Internet service provider (ISP), a Wireless Internet Server (WIS), a Wireless Internet Service Provider, a virtual private network (VPN), an intranet, a dial-up access device such as a modem, or other manner of connecting to network 118.

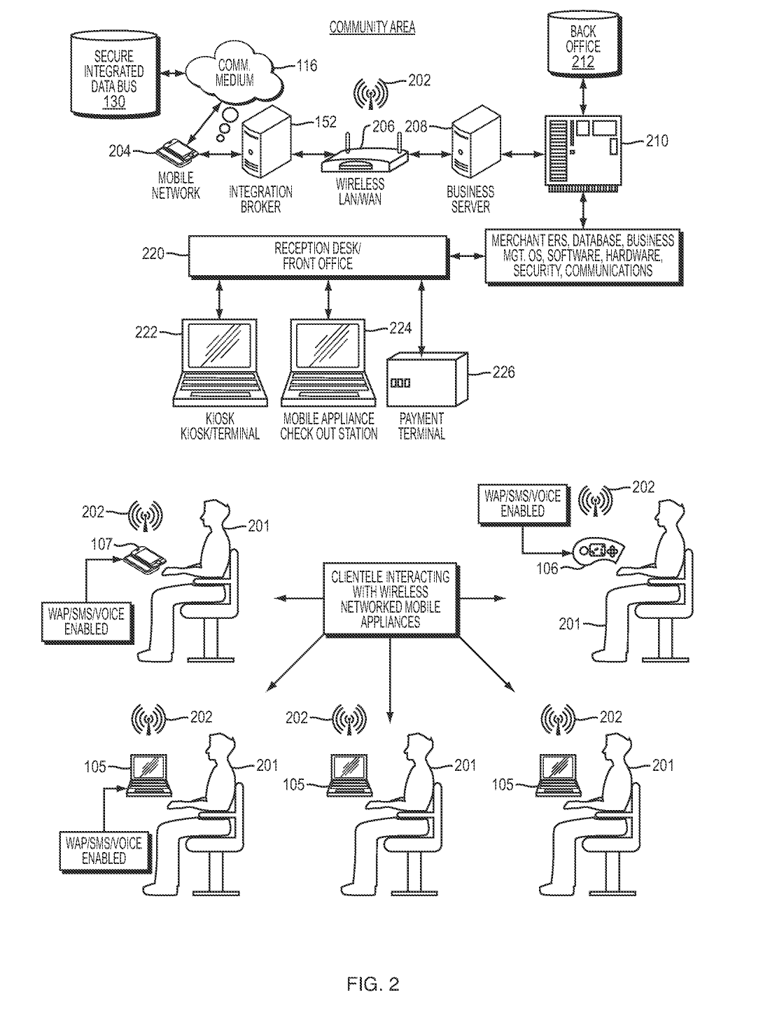

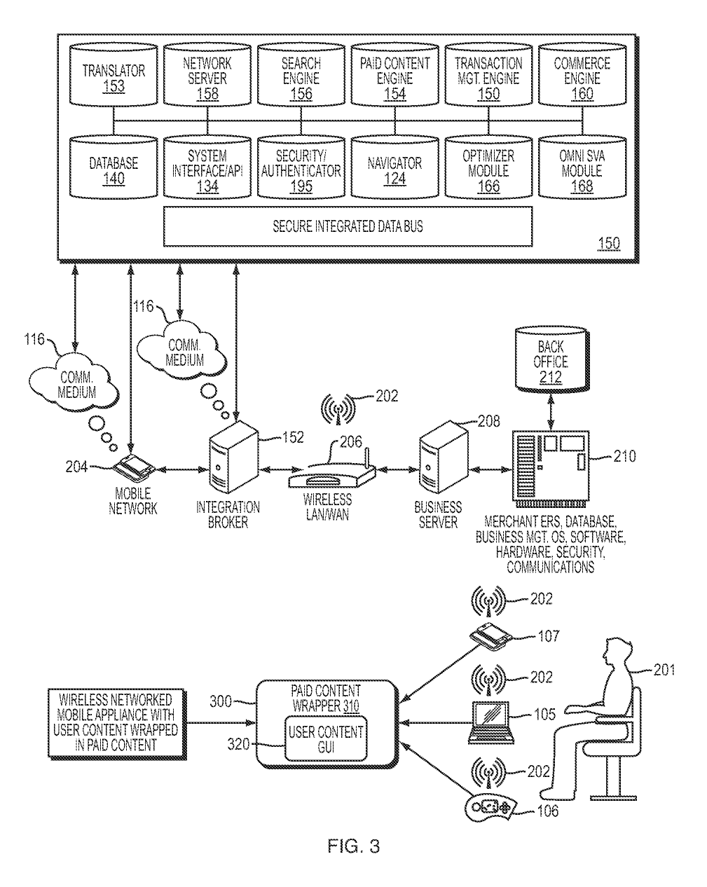

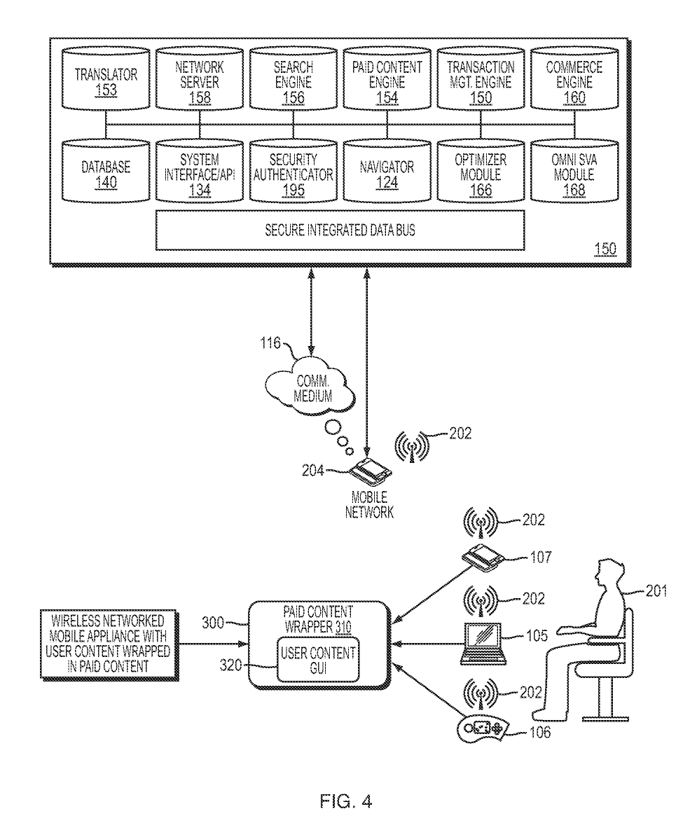

FIG. 2 illustrates five exemplary clients 201 using different displays 105, 106 and 107 connected to a communications medium 116 over a wireless network 202 and through three communications apparatus: a Wireless LAN/WAN 206, the Integration Broker 152 and the Mobile Network 204. It is to be understood that in practice less or significantly more users may be connected or connectable to an electronic mobile commerce system 100 than shown in FIG. 2, including through one or more communications mediums 116. To this point, FIGS. 3 and 4 further illustrate various other embodiments of the present teachings, and the present teachings are not limited thereto.

The electronic mobile commerce system 100 may include a processor 124, which may also have a connection to the network 118. Processor 124 may communicate with one or more data storage modules 140, discussed in more detail below.

Each of clients 101 used by commerce initiators to manipulate business administration processes, commerce transactions and customer service functions and accounts may contain a processor module 103, a display module 104, and a user interface module 102, although not limited thereto. The user interface module 102 may be for interacting and controlling the computer. The user interface module 102 may be, include or interface to one or more of a keyboard, joystick, touchpad, mouse, scanner or similar device or combination of devices. In one embodiment, the display module 104 may be or include a graphical user interface (GUI) to input data and conduct other transactions, viewing and interactive tasks.

The processor 124 may maintain a connection to the network 118 through transmitter module 120 and receiver module 122. Transmitter module 120 and receiver module 122 may be or include conventional devices which enable processor 124 to interact with network 118. According to an embodiment of the present teachings, transmitter module 120 and receiver module 122 may be integral with processor 124. The connection to network 118 by processor 124 and clients 101 may be a broadband connection, such as through a T1 or T3 line, a cable connection, a telephone line connection, DSL connection, a wireless network connection or any other type connection.

Processor 124 may function to communicate with clients 101 and permit clients 101 to interact with each other in connection with transaction services, commerce services, messaging services, customer services and other services and functions which may be provided through the electronic mobile commerce system 100.

The processor 124 may also communicate with a number of data storage modules 140. Each data storage module 140 may store various information associated with the electronic mobile commerce system 100 to synergize and optimize business administration processing, commerce transactions and customer service functions within the community. The community may consist of clients, merchants, third party administrators and others. The databases may include, although not limited thereto, a system specific database 141, User Specific Database 142, Merchant Specific Database 143, Affinity Specific Database 144, Administration Specific Database 145, Education Specific Database 146, Entertainment Specific Database 147, and Marketplace & Commerce Specific Database 148, which will be discussed in detail further below.

According to one embodiment of the present teachings, each of data storage modules 140 may be located on one or more data storage devices, where the data storage devices are combined or separate from processor 124. Each of data storage modules 140 may be, include or interface to, for example, the Oracle™ relational database sold commercially by Oracle Corp., although not limited thereto. Other databases, such as Informix™, DB2 (Database 2), Sybase™ or other data storage or query formats, platforms or resources such as OLAP (On Line Analytical Processing), SQL (Standard Query Language), a storage area network (SAN), Microsoft Access™ or others may also be used, incorporated or accessed in the present teachings. Each of data storage modules 140 may be supported by a server or other resources, and may in embodiments which include redundancy, such as a redundant array of independent disks (RAID) for data protection.

The electronic mobile commerce system 100 of the present teachings may be optimized by the Secure Integrated Data Bus 130 which may include the System Interface/API 134, the Security/Authenticator 138, the Database 140 and the Transaction Management Engine 150, although not limited thereto.

The electronic mobile commerce system 100 of the present teachings may also be optimized by the Transaction Management Engine 150 that facilitates, coordinates and manages transaction logic and synergizes multiple user interfaces, relationships and requests to the benefit of the user. The Transaction Management Engine 150 may integrate and synergize the utility and functionality of multiple engines, systems and modules. It may include a Translator 153 that facilitates and manages internal system interface communications, language and logic. It may also include an integration broker 152 that facilitates and manages external interface communications, integration, language, logic and compatibility with external third party software, or with interfaces and applications such as the mobile electronic commerce system 100 and the various User 108, Merchant 110, TPA 112, and Banking 114 interfaces as well as other external software and systems architectures of external applications and software systems. It may include a paid content engine 154 that provides paid content and related revenue generation tools, applications and interfaces to the benefit of the electronic mobile commerce system 100. A content search engine 156 may facilitate content search and provide content search related tools, applications and interfaces. It may provide a Navigator 158 that facilitates, manages and monitors system, security and interface tracking, location sensitivity and logistics, time sensitivity and service monitoring functions, alerts, notifications, appointments and schedules. It may also include a Commerce Engine 160 that facilitates and manages commerce related interfaces, logic, transactions, functions and rules.

Optimization of the mobile electronic commerce system 100 by the Transaction Management Engine 150 may be further optimized by the Commerce Engine 160. The Commerce Engine 160 may facilitate and manage commerce related interfaces, logic, transactions, functions and rules. The Commerce Engine 160 may be further optimized by a Rules Interface 161 which governs and coordinates commerce engine 160 related logic and integration with the SIDB 130 and manages the synergistic relationships and functions between the Billing—Accounts Receivable Module 162, the Payment—Accounts Payable Module 164, the Optimization—Commerce Relationship Logic module 166, the Omni Stored Value Accounts Module 168, and the Market Place Module 170 and the Affinity Module 180.

The Billing—Accounts Receivable Module 162 may facilitate commerce-related accounting functions typical of an accounts receivable system, to also include electronic ordering, order tracking and billing functions.

The Payment—Accounts Payable Module 164 may facilitate commerce-related accounting functions typical of an accounts payable system, to also include electronic deposits, wire transfers and the accounting of affinity, credit, token and/or some other stored values on behalf of a user.

The Optimization—Commerce Relationship Logic Module 166 may work in coordination with the Rules Interface 161 and security authenticator 138 to facilitate commerce related transactions and relationship management, and communication and coordination between, among and across multiple parties and interfaces. It may further act as a commerce gateway to authenticate transaction authorizations, track transactions and monitor the commerce engine 160 relationships, interfaces and system integrity.

The Omni—Stored Value Accounts Module 168 may serve as a clearinghouse for the aggregation of users' Stored Values. In this way, the system may manage user preferences and rules related to the types and kinds of stored values the user desires to aggregate from specific relationships. The Omni—SVA module 168 may further store, track and document the aggregation of user's stored values and provide user knowledge and alerts related to stored value redemption incentives, expiration and stored value accumulation opportunities in the marketplace.

The Market Module 170 may serve as an interactive community marketplace wherein merchant products and services are displayed. In this way, the Market Module 170 may work in coordination with the Rules Interface 161 and the associated modules of the Commerce Engine 160, the associated modules and engines of the Transaction Engine 150, as well as the associated modules of the Database 140 to facilitate a secure environment within which the community can interactively conduct commerce, aggregate stored values and optimize relationships among one another. One optimized function of the electronic mobile commerce system 100 as it relates to the Market Module 170 is that it may further allow merchants and/or their suppliers, through the Education Database 146 and Marketplace Database 148 and System Interface/API 134, to attach interactive content to specific products and/or services that a commerce initiator can view in advance of their purchase. This provides real time product education and/or competitive comparison to the mobile consumer. A further optimized function of the electronic mobile commerce system 100 as it relates to the Market Module 170 is that it can coordinate with the Optimization—Commerce Relationship Logic Module 166, Rules Interface Module 161, Omni SVA Module 168 as well as the Affinity Module 180, to alert both the Merchant and commerce initiator and/or Third Party to relationship discounts, group purchasing discounts, sales incentives and/or affinity incentives, although not limited thereto. It can customize incentives in real time and negotiate pricing, discounts and incentives directly with the consumer and/or third party to expedite closure of the sale. The market module 170 can further facilitate bartering. Once a sale is made in the market module 170 it may facilitate transaction communication, tracking and updating to the Optimization—Commerce Relationship Logic Module 166, Rules Interface Module 161, Omni SVA Module 168, as well as the Affinity Module 180 and/or any other module to facilitate and maintain system currency.

The Affinity Module 180 may serve as a clearinghouse for the administration of merchant and/or third party Affinity programs. The system can manage merchant and/or third party affinity program offerings and rules related to the types and kinds of affinity programs the merchant and/or third party desire to administer and/or offer to specific commerce initiators. The Affinity module 180 may further store, track and document the relationships between commerce initiators, merchants and/or third parties and provide user knowledge and alerts related to affinity program updates, incentives and opportunities in the marketplace.

The electronic mobile commerce system 100 of the present teachings may be optimized by the Database 140 that may include multiple databases that synergize integration and utilization of system content to the benefit of multiple users and multiple functions. The databases may include System Specific Database 141, User Specific Database 142, Merchant Specific Database 143, Affinity Specific Database 144, Administration Specific Database 145, Education Specific Database 146, Entertainment Specific Database 147, and Marketplace & Commerce Specific Database 148. It is to be further understood that the Database 140 and its associated sub-database modules are exemplary and that in practice less or significantly more database modules may be connected or connectable to an electronic commerce system 100.

System Database 141 may store information, data, records and relational data specific to the functions and integrity of the electronic mobile commerce system 100, which may include internal as well as external relational data. It is to be further understood that the system database 141 is exemplary and that in practice less or significantly more data and/or content of any kind may be assigned to or contained within an system database 141 connected or connectable to an electronic commerce system 100.

The User Database 142 may store information, data, records and relational data specific to individual and/or groups of users and/or commerce initiators, which may include personalized profiles, user rules, user customization and settings, user specific documents and records (such as Medical Records, Shopping Lists, Service Preferences), and user assigned data and content, in whatever forms or types and records. It is to be further understood that the user database 142 is exemplary and that in practice less or significantly more data and/or content of any kind may be assigned to or contained within a user database 142 connected or connectable to an electronic commerce system 100

The Merchant Database 143 may store information, data, records and relational data specific to individual and/or groups of merchants and/or third party administrators, which may include personalized profiles, rules, customization and settings, specific documents and records (such as product lists, lists of services, prices, etc.), and assigned data and content, in whatever forms or types and records. The Merchant Database 143 may be used for merchants to also store data specific to their physical location and the location of products and services located within their facility and/or the ID, signal or beacon, in whatever form or type it may be, of a product inside or outside their facility. In this way, working in coordination with Navigator 158, it can provide the location data and said ID, signal and/or beacon specific to a facility and/or the location of a product within or outside a facility so that said facility and/or product and/or service can be tracked and located by a commerce initiator, merchant or third party. It is to be further understood that the merchant database 143 is exemplary and that in practice less or significantly more data and/or content of any kind may be assigned to or contained within an merchant database 143 connected or connectable to an electronic commerce system 100.

The Affinity Database 144 may store information, data, records and relational data specific to individual and/or groups of Users, merchants and/or third party administrators, which may include programs, program profiles, rules, customization and settings, specific documents and records (such as marketing lists, media promotion content) and assigned data and content, in whatever forms or types and records. It is to be further understood that the affinity database 144 is exemplary and that in practice less or significantly more data and/or content of any kind may be assigned to or contained within an affinity database 144 connected or connectable to an electronic commerce system 100.

The Administration Database 145 may store information, data, records and relational data specific to individual and/or groups of Users, merchants and/or third party administrators, which may include programs, program profiles, rules, customization and settings, specific documents and records (such as menu data 502, enrollment data 504, ordering & SKU data 506, authentication data 508, payment forms and source data 510, documents 512, billing data 514, eligibility data 516, messaging data 518, finance data 520, vital records data 524, affinity data 526, etc.) and assigned data and content, in whatever forms or types and records. It is to be further understood that the administration database 145 is exemplary and that in practice less or significantly more data and/or content of any kind may be assigned to or contained within an administration database 145 connected or connectable to an electronic commerce system 100.

The Education Database 146 may store information, data, records and relational data specific to individual and/or groups of Users, merchants and/or third party administrators, which may include programs, program profiles, rules, customization and settings, specific documents and media content (such as Information and Frequently Asked Questions 530, Animations 532, Videos & Images 534, Internet Search 536, Other 538, Interactive Activity & Social Networking 540) and assigned data and content in whatever forms or types and records of the like. It is to be further understood that the education database 146 is exemplary and that in practice less or significantly more data and/or content of any kind may be assigned to or contained within an education database 146 connected or connectable to an electronic commerce system 100.

The Entertainment Database 147 may store information, data, records and relational data specific to individual and/or groups of Users, merchants and/or third party administrators, which may include programs, program profiles, rules, customization and settings, specific documents and media (such as Media & Internet 550, Entertainment 552, Network 554, Gaming 556, Other 558, Interactive Activity & Social Networking 560, etc.) and assigned data and content, in whatever forms or types and records. It is to be further understood that the entertainment database 147 is exemplary and that in practice less or significantly more data and/or content of any kind may be assigned to or contained within an entertainment database 147 connected or connectable to an electronic commerce system 100.

The Market Place Database 148 may store information, data, records and relational data specific to individual and/or groups of Users, merchants and/or third party administrators, which may include programs, program profiles, rules, customization and settings, specific documents and media (such as products, services, prices, promotions, media content, lists, providers, commercials, testimonials, etc.) and assigned data and content, in whatever forms or types and records. It is to be further understood that the marketplace database 148 is exemplary and that in practice less or significantly more data and/or content of any kind may be assigned to or contained within an marketplace database 148 connected or connectable to an electronic commerce system 100.

While one embodiment of a supporting architecture has been described, it is to be understood that other architectures could support the operation of Electronic Mobile Commerce System 100 and the present teachings are not limited to any particular embodiment. In general, the Electronic Mobile Commerce System 100 is designed to allow Merchants, Clients and Third Parties the ability to transact business administrative processes, commerce transactions and/or customer service functions autonomously and expeditiously in an intuitive, integrated and optimized manner.

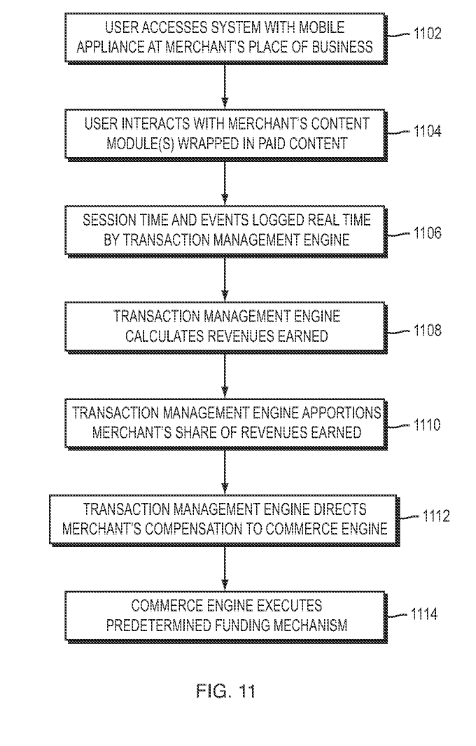

There are various possibilities with regard to the relative methods of how a merchant desires to facilitate or is required to facilitate the business administrative processes, commerce transactions and customer service functions of its enterprise. In any event the Merchant can customize the electronic mobile commerce system 100 interface according to the sequential logic and navigation process illustrated in FIG. 10 to optimize the commerce initiator's interaction and maximize the revenue generation derived from the commerce initiator's viewing and/or interaction with paid content, as illustrated in FIG. 11.

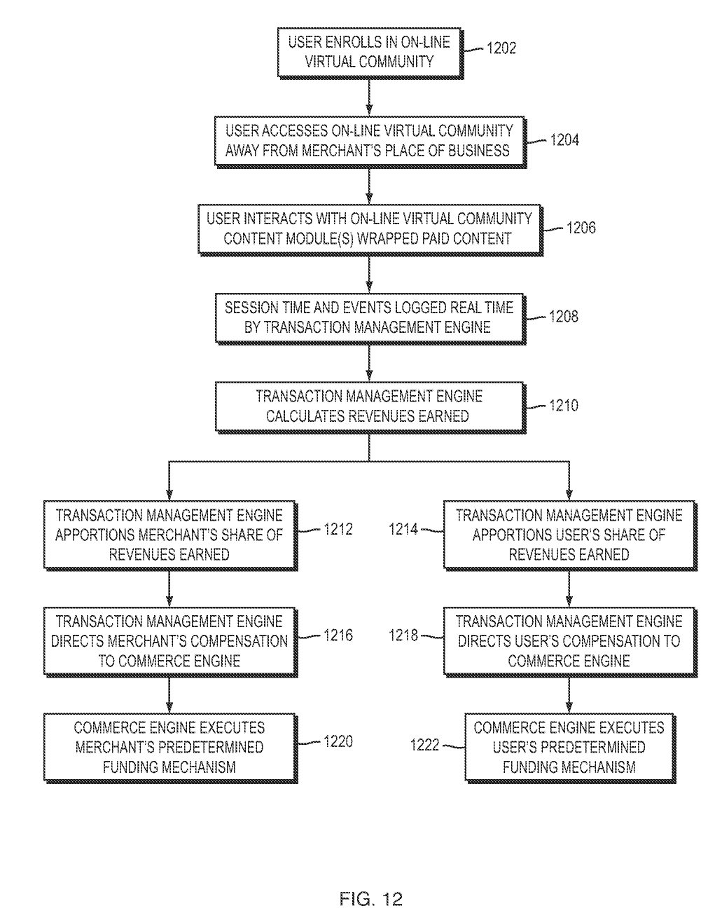

There are also various possibilities of how a commerce initiator may desire to interact with or is required to interact with the business administrative processes, commerce transactions and customer service functions of the enterprise they are soliciting products and/or services from. In any event, the commerce initiator may be incentivized to navigate and interact with the Merchant's customized electronic mobile commerce system 100 interface according to the sequential logic and navigation process, as illustrated in FIG. 10, as it maximizes the commerce initiator's revenue generation opportunity derived from the commerce initiator's viewing and/or interacting with said paid content, as illustrated in FIG. 12.

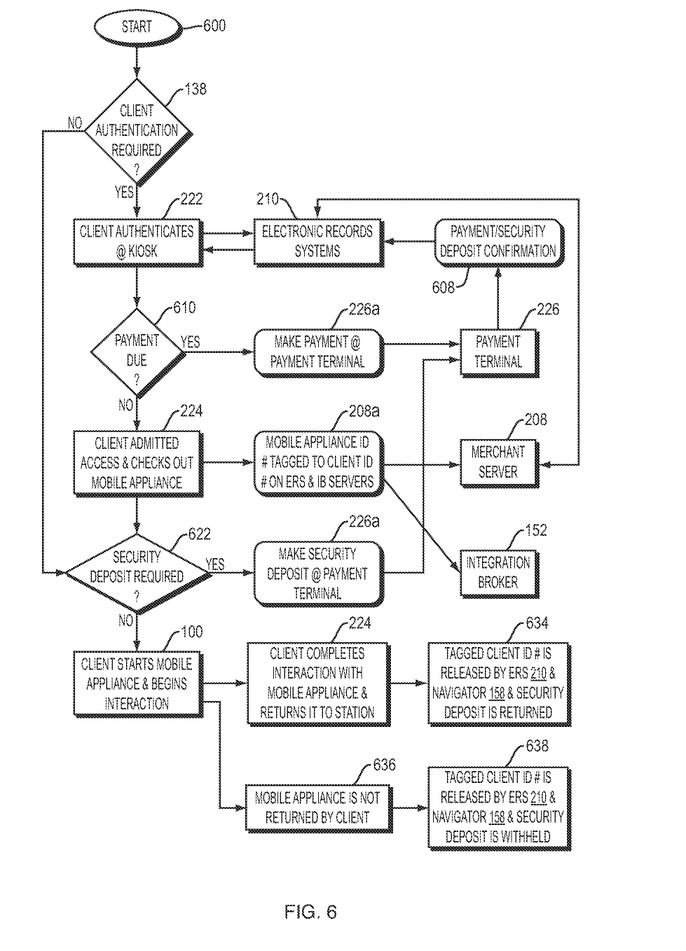

FIG. 2 relates an embodiment of the present teachings that illustrates a Community Area, wherein a plurality of Users 201 may interact over a mobile network 202, 204, 206 using client modules 101 and their various related displays 105, 106, 107. It is intended to illustrate in this embodiment that upon check-in to the Reception Desk/Front Office 220 a user may engage a Kiosk 222 where the User 201 identifies, authenticates and/or registers him- or herself. Upon registration, the User 201 may be assigned or rented the Client Module 101 in the form of their preferred display 105, 106, 107. The User 201 may select their preferred display 105, 106, 107 from the Mobile Appliance Check out Station 224. If the Client module was rented and/or if the User 201 was required to make a payment of any kind, for instance the User 201 was required to pay a Co-Pay deductible at their Medical Providers Office, they may make their payment at the Payment Terminal 226, as further illustrated in FIG. 6. It is appreciated that kiosk may not be necessary if the user is authenticated through his or her own mobile device, although not limited thereto.

FIG. 3 relates an embodiment of the present teachings that provides an exemplary illustration of the User 201 interacting with the Client Module 101 and its Graphic User Interface 300 on its various related displays 105, 106 and 107 over a wireless communications network 202, 204, 206. This exemplary illustration shows the Graphic User Interface 300 partitioned to display both Paid Content 310 and User Content 320.

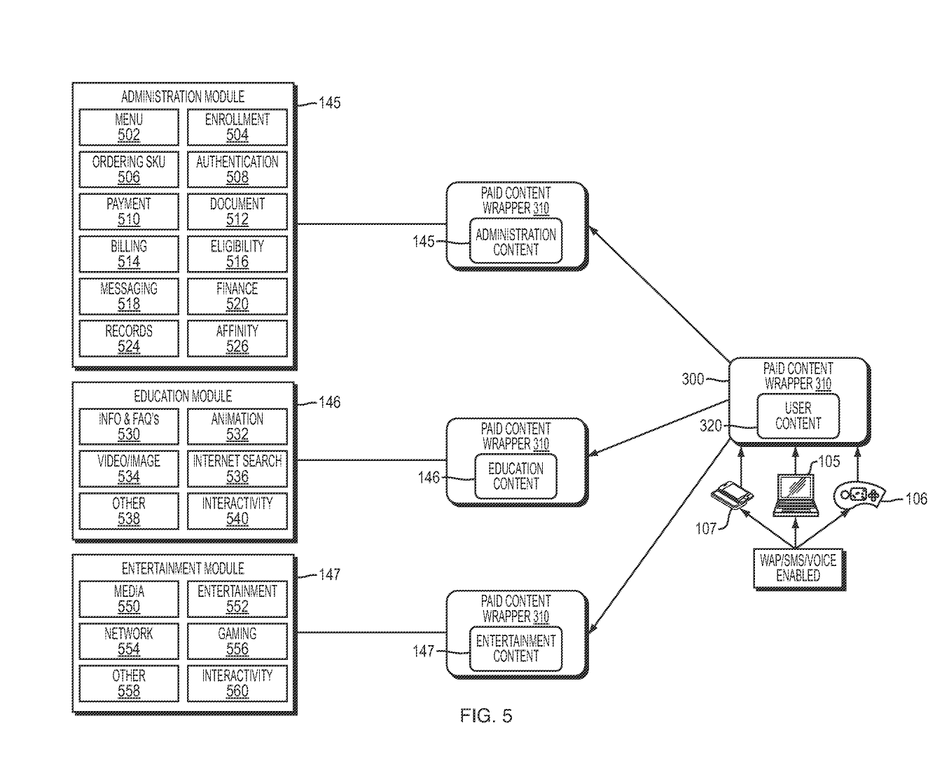

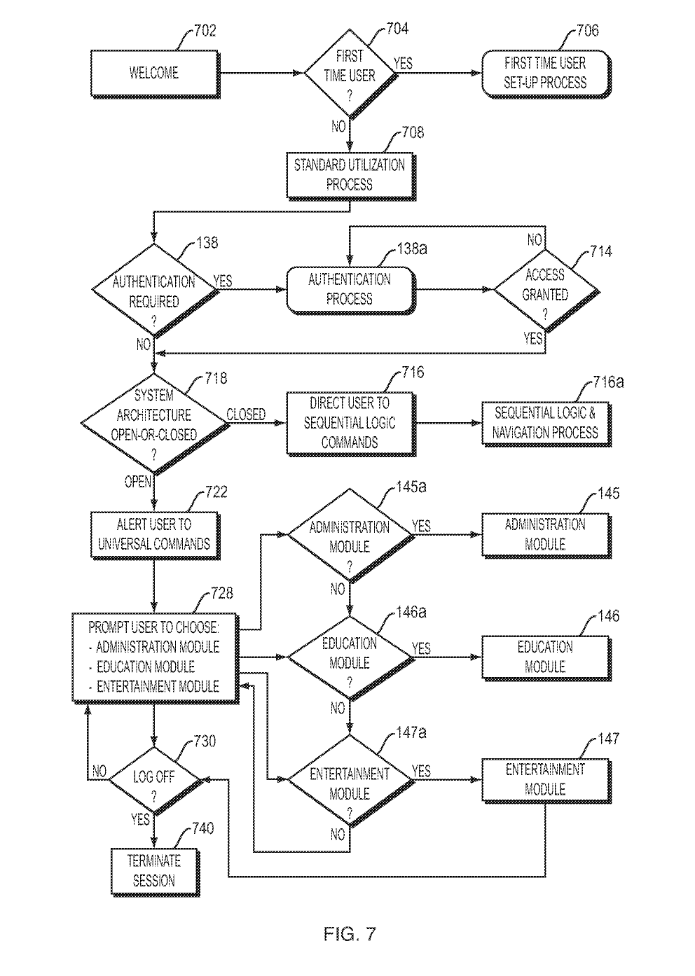

Accordingly, FIG. 5 expands upon FIG. 4 to illustrate the partitioned Graphic User Interface 300 contained on Client Module 101 and its related displays 105, 106, 107. In this embodiment of the present teachings the partitioned Graphic User Interface 300 is expanded into three disparate Graphic User Interfaces partitioned to illustrate the intended Administration Module 145 and its associated Paid Content Wrapper, the Education Module 146 and its associated Paid Content Wrapper and the Entertainment Module 147 and its associated Paid Content Wrapper. In addition the Administration Module, Education Module and Entertainment Module are further expanded to show their associated sub-content modules lending definition to the illustrations of FIG. 7 and again to the illustrations of FIG. 10.

In practice a commerce initiator may, according to the sequential logic and navigation process illustrated in FIG. 10, interface with one or all of the User Content Modules. Commensurately, the commerce initiator may also navigate or be navigated toward specific sub-content modules within a related User Content Module. It will be understood that in practice less or significantly more User Content Modules and/or sub content modules may be connected or connectable to an electronic mobile commerce system 100. It is to be further understood that the sequential logic and navigation process illustrated in FIG. 10 is exemplary and that in practice less or significantly more sequential logic and navigation processes may be connected or connectable to an electronic commerce system 100.

According to an embodiment of the present teachings, an optimization function may be used by electronic mobile commerce system 100 to optimize the mechanisms for facilitating business processes, commerce transactions and customer service at a location-based enterprise. By way of example, for instance, using electronic mobile commerce system 100 of the present teachings, a commerce initiator soliciting services at a medical provider's facility could, upon arrival, present at the Reception Desk/Front Office 220. According to FIG. 6, the commerce initiator, or “Patient” for this example, could register for service or “check-In” using the Kiosk 220. The Kiosk 220 may assist the patient to verify and authenticate their identity 138, as illustrated in FIG. 9, and confirm their appointment with the Medical Providers Electronic Records System (ERS) 210. The Kiosk may then query the ERS 210 to discern if an insurance co-payment or other payment is due. If a payment is due the patient may be directed to the payment terminal 226 to make payment. The patient may then be assigned a Client Module 101, according to their display preference 105, 106, 107, at the Mobile Appliance Check out Station 224. The assigned Mobile Appliance Client Module 101 and display 105, 106 or 107 may be “tagged” to the Provider's ERS 210 and electronic mobile commerce system's Navigator 158 to document the patient's possession of the assigned Mobile Appliance Client Module 101 and display 105, 106 or 107. It may further securely interface, monitor, track and provide logistical services, as the case may be, to the benefit of both the patient and provider throughout the service.

The patient may then take a seat in the provider's waiting room and/or facility and wait for their provider to see them. This may facilitate the business administrative tasks related to their relationship and the intended services being solicited from the medical provider. The patient, with the Mobile Appliance Client Module 101 and related Display 105, 106 or 107 in hand, may view the Graphic User Interface 300 to see the Paid Content 154 along with the User Content 320. The Paid Content 154 may remain active and constant throughout the Patient's interaction with various content modules, generating paid content revenue on behalf of the Provider and/or Patient and/or Third Party, depending on the rules and permissions assigned to the Electronic Mobile Commerce System 100, as the case may be. It will be understood that in practice customization of the rules interface module 161 by the merchant and/or third party through their respective merchant interface 110 and/or TPA interface 112 will dictate whether, and/or at what point in the commerce initiator's interaction, commerce initiators may view or derive revenue from paid content 154.

As illustrated in FIG. 7, in the medical provider environment the patient may then be welcomed 702 to the provider's office. The welcome may include a personal introduction in the form of a letter, image, video clip or media presentation administered by the provider's interface 110 with their merchant database 143 located within the database 140 and further contained within the SIDB 130 of the electronic mobile commerce system 100, although not limited thereto. If the Patient is a First Time User 704 it may facilitate the First Time User Set up Process 706, as illustrated in FIG. 8.

Following FIG. 7, in the interests of time the patient, having already been identified and authenticated 138 at the Kiosk 220 according to the exemplary illustration of FIG. 9, may be advanced to the sequential logic and navigation process, as illustrated in FIG. 10, to facilitate the administrative tasking related to the registration process. In this case, the System Architecture 718 may be CLOSED. The patient may be directed to the Administration Module 145.

Now following FIG. 10 and using FIG. 5 as a detailed reference, the patient may be required to administer Sub Module A. In this case, Sub Module A relates to Menu Module 502 wherein the patient may reference a checklist of forms and questions to be completed. The patient may be directed to acknowledge their directive to complete the administrative tasking specified in Menu Module 502 and complete any informal admissions criteria or acknowledgements by the provider, as the case may be. Upon completion the Menu Module 502 tasking may be verified by Optimizer Module 166 and confirmed and archived in User Database 142 and/or Merchant Database 143, as the Rules Interface 161 determines, or may be electronically resubmitted to the patient for completion accuracy, although not limited thereto.

The patient may then be directed to Sub Module B. In this case, Sub Module B relates to Enrollment Module 504. The patient may be directed to acknowledge their directive to complete the administrative tasking specified in the Enrollment Module 504 and complete the various tasks required by the Provider, as the case may be. Upon completion the Enrollment Module 504 tasking may be verified by Optimizer Module 166 and confirmed and archived in User Database 142 and/or Merchant Database 143, as the Rules Interface 161 determines, or may be electronically resubmitted to the patient for completion accuracy, although not limited thereto.

The patient may be directed to Sub Module C. In this case, Sub Module C relates to Document Module 512. The patient may be directed to acknowledge their directive to complete the administrative tasking specified in the Document Module 512 and complete the various tasks required by the Provider, as the case may be. In the Medical Provider setting these documents typically relate to: the patient's personal and professional information; the patient's personal and family medical history; emergency care and care related directives; the patient's acknowledgement of financial responsibility; the patient's acknowledgement of consent to treatment; the patient's acknowledgement of legal rights; patient confidentiality and release of liability provisions; and related documents requiring authorization and signatory, although not limited thereto. One advantaged embodiment of the electronic mobile commerce system 100 is the ability for the commerce initiator to facilitate electronic signatory. Upon completion the Document Module 512 tasking may be verified by Optimizer Module 166 and confirmed and archived in User Database 142 and/or Merchant Database 143, as the Rules Interface 161 determines, or may be electronically resubmitted to the patient for completion accuracy, as the case may be.

The patient may be directed to Sub Module D. In this case, Sub Module D relates to Eligibility Module 516. The patient may be directed to acknowledge their directive to complete the administrative tasking specified in the Eligibility Module 516 and complete the various tasks required by the Provider, as the case may be. In the medical provider setting these documents typically relate to Insurance provider information and eligibility. One optimization function of the Eligibility Module 516 may be that it interfaces via the TPA Interface 112 with the Insurance Provider to facilitate Insurance benefit authentication, verification and approval along with any co-pays or deductibles that would be owed by the patient to the provider. Upon completion the Eligibility Module 516 tasking may be verified by Optimizer Module 166 and confirmed and archived in User Database 142 and/or Merchant Database 143, as the Rules Interface 161 determines, or may be electronically resubmitted to the patient for completion accuracy, as the case may be. In addition, the Eligibility Module 516 may communicate with the Billing Module 162 on behalf of the merchant 110 to generate a bill related to the patient's financial responsibility for the provider's services.

The patient may be directed to Sub Module E. In this case, Sub Module E relates to Payment Module 510. The patient may be directed to acknowledge their directive to complete the administrative tasking specified in the Payment Module 510 and complete the various tasks required by the Provider, as the case may be. In this case, the patient may be requested to pay their bill. In which case, the patient could facilitate payment to the Provider by authorizing Payment Module 164 of the Commerce Engine 160 to facilitate a transaction, according to the Rules interface 161, to be administered with the oversight of the Transaction Engine 150 to the Banking Interface 114. In another case, the patient could defer payment by requesting the Billing Module 162 to send them the bill. Upon completion or deferment of payment the Payment Module 510 tasking may be verified by Optimizer Module 166 and confirmed and archived in User Database 142 and/or Merchant Database 143, as the Rules Interface 161 determines, or may be electronically resubmitted to the patient for completion accuracy, as the case may be.

The patient may be directed to Sub Module F. In this case, Sub Module F relates to Affinity Module 526. The patient may be directed to acknowledge their directive to complete the administrative tasking specified in the Affinity Module 526 and complete the various tasks required by the Provider, as the case may be. In this case, the patient may enroll in a Health Funding Account to be administered by the Affinity Module 180, and overseen by the Rules interface 161 and further optimized by the Optimizer 166, directing some or all of their share of earned revenues, derived from their viewing of paid content 154, to be stored in the Omni SVA 168 and/or deposited in a designated deposit account through the Banking Interface 114, although not limited thereto. Upon completion the Affinity Module 526 tasking may be verified by Optimizer Module 166 and confirmed and archived in User Database 142 and/or Merchant Database 143, as the Rules Interface 161 determines, or may be electronically resubmitted to the patient for completion accuracy, as the case may be.

The patient may be directed to Sub Module G. In this case, Sub Module G relates to Records Module 524. The patient may be directed to acknowledge their directive to complete the administrative tasking specified in the Records Module 524 and complete the various tasks required by the Provider, as the case may be. In the medical provider setting, the patient may opt to have all of their Electronic Medical Records aggregated and archived onto the Records Module 524 for future use, evaluation and/or dissemination. Upon completion the Records Module 524 tasking may be verified by Optimizer Module 166 and confirmed and archived in User Database 142 and/or Merchant Database 143, as the Rules Interface 161 determines, or may be electronically resubmitted to the patient for completion accuracy, as the case may be.

Finally, the patient may be directed to Sub Module H. In this case, Sub Module H relates to Messaging Module 518. The patient may be directed to acknowledge their directive to complete the administrative tasking specified in the Messaging Module 518 and complete the various tasks required by the Provider, as the case may be. In the medical provider setting the patient may send their Provider or a different Provider a confidential e-mail or other communication relating a message or records transmission. Upon completion the Messaging Module 518 tasking may be verified by Optimizer Module 166 and confirmed and archived in User Database 142 and/or Merchant Database 143, as the Rules Interface 161 determines, or may be electronically resubmitted to the patient for completion accuracy, as the case may be.

Once all Administration Sub Module Tasks are completed 1024, the patient may be directed to the Education Module 146 wherein the patient may be again directed to Sub Module A of the Education Module. In this case, Sub Module A relates to Information and Frequently Asked Questions Module 530. The patient may be directed to acknowledge their directive to complete the educational tasking specified in the Info & FAQ Module 530 and complete the various tasks required by the Provider, as the case may be. In the medical provider setting this may relate to the patient's disease state, anatomy, treatment options, medications and/or any information relevant to the patient and/or their condition. The Education Module may also be an interactive module that allows the patient to ask and research questions of their provider and/or other experts. Upon completion the Info & FAQ Module 504 tasking may be verified by Optimizer Module 166 and confirmed and archived in User Database 142 and/or Merchant Database 143, as the Rules Interface 161 determines, or may be electronically resubmitted to the patient for completion accuracy, as the case may be.

The patient may be directed to Sub Module B of the Education Module. In this case, Sub Module B relates to Animation Module 532. The patient may be directed to acknowledge their directive to complete the educational tasking specified in the Animation Module 530 and complete the various tasks required by the Provider, as the case may be. In the medical provider setting this may relate to animations related to the patient's disease state, anatomy, treatment options, medications and/or any information relevant to the patient and/or their condition. Upon completion the Animation Module 532 tasking may be verified by Optimizer Module 166 and confirmed and archived in User Database 142 and/or Merchant Database 143, as the Rules Interface 161 determines, or may be electronically resubmitted to the patient for completion accuracy, as the case may be.

The patient may be directed to Sub Module C of the Education Module. In this case, Sub Module C relates to Interactivity Module 540. The patient may be directed to acknowledge their directive to complete the educational tasking specified in the Interactivity Module 540 and complete the various tasks required by the Provider, as the case may be. In the medical provider setting this may relate to social networking groups that share and discuss information related to their shared disease states, anatomy, treatment options, medications and/or any information relevant to the shared topics of the patient's social network. Upon completion the Interactivity Module 540 tasking may be verified by Optimizer Module 166 and confirmed and archived in User Database 142 and/or Merchant Database 143, as the Rules Interface 161 determines, or may be electronically resubmitted to the patient for completion accuracy, as the case may be.

The patient may be directed to the Entertainment Module 147 wherein the patient may again be directed to Sub Module A of the Entertainment Module. In this case, Sub Module A relates to Media Module 550. The patient may be directed to acknowledge their directive to complete the entertainment tasking specified in the Media Module 550 and complete the various tasks required by the Provider, as the case may be. In the medical provider setting, the Entertainment Module 147 could be OPEN architected, allowing patients and/or commerce initiators the ability to enjoy their remaining time spent waiting for services to be delivered watching media content, reading media content or engaging in personal productivity functions such as e-mail or accessing their work-related VPN. The Entertainment Module 147 may include any type or kind of sub module content conducive to the entertainment and pacification of a commerce initiators time spent waiting for products and/or services to be provided. The Entertainment Module may also be an interactive module that allows the patient and/or commerce initiator to interact with others on the Internet, blog sites, social networks, interactive gaming locations, etc. For instance, children in a pediatrician's office or hospital could create virtual identities and engage in remote, interactive gaming with one another as an optimized embodiment of the functionality of the electronic mobile commerce system 100.

Throughout the Patient's interaction with the mobile appliance module 101 and associated interfaces 105, 106, 107 the patient may view a timer located within the User Content 154 on the Graphic User Interface 300. As the provider becomes available to see the patient the User Content 154 may display the navigator 158 interface that navigates the Patient, via GPS navigation and/or any other form of logistical tracking and positioning system, to where they may find the Provider. In the medical provider setting this is typically an examination room.

During the patient's interaction with the provider in the examination room, the provider may have instantaneous access to the Patient's records and can update, modify, edit or add content and/or records to the patient's record module 524 as the provider deems necessary. Upon completion the Records Module 524 tasking may be verified by Optimizer Module 166 and confirmed and archived in User Database 142 and/or Merchant Database 143, as the Rules Interface 161 determines, or electronically resubmitted to the patient or provider for completion accuracy, as the case may be.

Upon completing their interaction with their provider, the patient may sign off of their user interface 108 and corresponding account with the electronic mobile commerce system 100. The optimizer 166 may then be commissioned automatically to aggregate and document the billing associated with the providers (Merchants), patients (commerce initiators) and/or third parties' share of paid content revenue, as governed by the rules interface 161, derived from the patients viewed and/or interacted paid content 154 during their interaction with the provider, although not limited thereto. The Optimizer 166 working in cooperation with the Paid Content Engine 154 may communicate the various parties' earned revenue share with the parties respective account located within database 140 and associated account within the Omni SVA module 168 and/or affinity module 180, whatever the case may be. Further, it may communicate the accounting payable to the billing module 162 and the accounting receivable to the payment module 164. The paid content engine 154 in cooperation with billing module 162 may manage the accounts receivable for paid and/or interacted content from external content providers 126 and/or third party applications 128 through the banking interface 114. Working collaboratively with the optimizer 166 and payment module 164, according to the rules governed by the rules interface 161, it may facilitate payment of the parties' earned revenues to the parties' respective stored value and/or currency accounts located within the electronic mobile commerce system 100 or to the parties respective stored value and/or currency accounts located outside the electronic mobile commerce system 100 through the Banking Interface 114.

The patient may return the Mobile Appliance Client Module 101 and associated display 105, 106 or 107 to the Mobile Appliance Check out Station 224 and, as illustrated in FIG. 6, the Tagged Client ID # may be released by the Provider's ERS 210 and Navigator Module 158 of the electronic mobile commerce system 101 and any associated deposits or collateral held by the Optimizer 166 and billing module 162 may be released and returned to the patient.

It is to be understood that in practice the mobile appliance client module 101 and associated display 105, 106 or 107 of the preceding example is intended to illustrate the advantage of an embodiment of the present teachings. An optimization function using electronic mobile commerce system 100 to optimize the mechanisms for facilitating business processes, commerce and customer service within a medical provider setting is not limited to merchant-assigned or rented mobile appliance client modules 101 and an advantaged embodiment of the present present teachings further includes the commerce initiator's utilization of privately owned or privately rented mobile appliance client module 101 and associated display 105, 106, 107 that may be connected or connectable to an electronic mobile commerce system 100.

The patient, provider or merchant and/or third party administrator may remotely access the electronic mobile commerce system 100 according to the access permitted by the patient, provider or merchant and/or third party, governed by the rules interface 161 and optimizer module 166, to review their records 524 and communicate via the messaging module 518 with one another. This may be done according to the communications confidentiality rules established by each, and governed by the rules interface 161.

The patient, provider or merchant and/or third party administrator may remotely access the electronic mobile commerce system 100 according to the access permitted by the patient, provider or merchant and/or third party, governed by the rules interface 161 and optimizer module 166, to socially interact and communicate within one another, via the Education Module 146 sub module 540 and/or via the Entertainment Module 147 sub module 560, again, according to the communications confidentiality rules established by each and governed by the rules interface 161.

By way of the preceding example it is intended to illustrate one advantage of an embodiment of the present teachings with an optimization function using the electronic mobile commerce system 100 to optimize the mechanisms for facilitating business processes, commerce and customer service within a medical provider setting and the present teachings are not limited thereto.

The advantaged illustration demonstrates streamlined administrative processing and logistical navigation. This may be facilitated exclusively and autonomously by the patient or commerce initiator, to the exclusion of utilizing the provider's or merchant's administrative or manpower resources to expedite administration and navigate the patient/commerce initiator.

The advantaged illustration further demonstrates streamlined communications and commerce that facilitates comprehensive security, authentication, tracking, data input, administrative tasking, verification of performance, confirmation of system accuracy, system coordination and optimization with records storage, automated direct and Third party communications, eligibility tracking, automated accounting, automated revenue generation as well as automated commerce transaction management and further eliminates redundant utilization of manpower and tasking, saving the merchant time and expense.

The advantaged illustration further demonstrates enhanced customer services and collaborative revenue generation methods benefiting all parties in the forms of patient/commerce initiator-directed processing and fulfillment of administrative tasking, preservation of administrative work product to the access and benefit of all parties, interactive education and interactive entertainment to the benefit of all parties and associated business process, management of time and expectations to the benefit of all parties, passive revenue generation and interactive revenue generation programs to the benefit and good fortune of all parties, and facilitation of affinity programs and stored value accounts to the benefit and good fortune of all parties.

According to an embodiment of the present teachings, an optimization function may be used by the electronic mobile commerce system 100 to optimize the mechanisms for facilitating business processes, commerce transactions and customer service at a location-based enterprise. By way of example, for instance, using the electronic mobile commerce system 100 of the present teachings, a commerce initiator soliciting services at a retail merchant facility such as a store could, upon arrival to the store, with their Mobile Appliance Client Module 101 and related Display 105, 106 or 107 in hand, “Sniff” or be “sniffed” by the Merchant's wireless network. The process of “Sniff” or “Sniffing” is an application known by those familiar in the art, wherein the commerce initiators Mobile Appliance Client Module 101 is recognized by the Merchant's wireless network, commonly known as the “Wi-Fi” network, although not limited thereto.

The commerce initiators Mobile Appliance Client Module 101 and related Display 105, 106 or 107 may be asked to join the network and/or join the network automatically. The network may be merchant-owned or public. The commerce initiator, or ‘Customer’ for this example, may then view their Mobile Appliance Client Module 101 and related Display 105, 106 or 107 to see and/or locate the Merchant and/or third party content on their displays Graphic User Interface 300 to see the Paid Content 154 along with the User Content 320. The Paid Content 154 may remain active and constant throughout the customer's interaction with various content modules, generating paid content revenue on behalf of the Merchant and/or customer and/or Third Party, depending on the rules and permissions assigned to the Electronic Mobile Commerce System 100, as the case may be. It will be understood that in practice, customization of the rules interface module 161 by the merchant and/or third party through their respective merchant interface 110 and/or TPA interface 112 will dictate whether, and/or at what point in the customers' interaction, they may view or derive revenue from the paid content 154.

As illustrated in FIG. 7 the Customer may then be welcomed 702 to the merchant's facility. The welcome may include a personal introduction, in the form of a letter, image, audio clip, video clip or media presentation administered by the Merchants interface 110 with their merchant database 143 located within the database 140 further contained within the SIDB 130 of the electronic mobile commerce system 100, although not limited thereto. If the Customer is a First Time User 704 it may facilitate the First Time User Set up Process 706, as illustrated in FIG. 8.

According to exemplary FIG. 7, if the system architecture 718 is OPEN the Customer may advance to the Universal Commands 728, as illustrated in FIG. 10, to facilitate the customer's desired shopping experience. Now following FIG. 10 and using FIG. 5 as detailed reference, the Customer may select Menu Module 502 of the Administration Module 145. The Customer may reference and interact with a menu or list of the merchant's products and/or services. The Customer may select any individual or a plurality of products or services they desire to purchase, learn more about and/or locate, as the case may be. Upon completion the Menu Module 502 tasking may be verified by Optimizer Module 166 and confirmed and archived in User Database 142 and/or Merchant Database 143, as the Rules Interface 161 determines, or may be electronically resubmitted to the Customer for completion accuracy, as the case may be.

The Customer may then select Sub Module B. In this case, Sub Module B relates to Ordering SKU Module 506. The Customer may then verify the products they wish to purchase, learn more about and/or locate. The Ordering SKU Module 506 in collaboration with Merchant Database 143 and Optimizer 166 may provide the customer with the product and/or services relevant ordering information such as its ordering, SKU or part number, price, affinity incentives and any specific information relevant to the purchase and tracking of the product and/or service. The Ordering SKU Module 506 in collaboration with Merchant Database 143 and Navigator 158 may further provide the customer logistical information and location search of the said selected products and/or services that enable the customer to autonomously track and locate said products and/or services. Accordingly, the Ordering SKU module 506 may be logic capable. It may be optimized by the Optimizer 166 and Translator 153 to accommodate whatever product discovery requests the customer may have related to specific products and/or services. In this way customer service and education may be optimized by the electronic mobile commerce system 100. Upon completion the Ordering SKU Module 506 tasking may be verified by Optimizer Module 166 and confirmed and archived in User Database 142 and/or Merchant Database 143, as the Rules Interface 161 determines, or may be electronically resubmitted to the Customer for completion accuracy, as the case may be.

According to the customer's product discovery request and/or purchase request the Optimizer Module 166, working collaboratively with the Translator Module 153, may invite the customer to view those modules specific to their stated product discovery request and/or modules related to their purchase request.

The Customer may then select the Education Model 146, wherein they select Sub Module A, although not limited thereto. In this case, Sub Module A relates to the Info & FAQ module 530. The Customer may then query the Info & FAQ Module 530 for information content specific to their desired products and/or services.

The Customer may then select Sub Module B. In this case, Sub Module B relates to the Animation module 532. The Customer may then query the Animation Module 532 for animations and/or interactive information specific to their desired products and/or services.

The Customer may then select Sub Module C. In this case, Sub Module C relates to the Interactivity module 540. The Customer may then query their social network and/or evaluate information specific to the desired product or service, such as user testimonials, product ratings, competitive information, comparative information and the like.

The customer may then return to the Administration Module and select Sub Module C. Sub Module C, in this case, relates to the Billing Module 514. Billing Module 514 may work in coordination with Ordering SKU Module 506, Optimizer 166 and Billing Module 162 of the Commerce Engine to complete the order of the customer's desired products and/or services, although not limited thereto.

The customer may then be invited to view Sub Module D. In this case, Sub Module D relates to Affinity Module 526. The Customer may be directed to acknowledge their directive to complete the administrative tasking specified in the Affinity Module 526 and complete the various tasks required by the Merchant, as the case may be. In this case, the Customer may enroll in a merchant-specific affinity account such as a Rewards Program or any other variety of affinity programs the customer and/or merchant may be associated with or aspire to become associated with. In the event that the customer is already associated with an affinity program, the customer may opt to have the affinity module 526 coordinate administration of any relevant affinity with the Affinity Module 180, as overseen by the Rules interface 161 and further optimized by the Optimizer 166, directing some or all of their share of earned revenues, derived from their viewing of paid content 154, to be stored in the Omni SVA 168 and/or deposited in a designated deposit account through the Banking Interface 114. Upon completion, the Affinity Module 526 tasking may be verified by Optimizer Module 166 and confirmed and archived in User Database 142 and/or Merchant Database 143, as the Rules Interface 161 determines, or may be electronically resubmitted to the Customer for completion accuracy, as the case may be.

The customer may be directed to Sub Module E which, in this case, relates to the Payment Module 510. The Customer may be directed to acknowledge their directive to complete the administrative tasking specified in the Payment Module 510 and complete the various tasks required by the Merchant, as the case may be. In this case, the Customer may be requested to pay their bill. In which case, the Customer could facilitate payment to the Merchant by authorizing Payment Module 164 of the Commerce Engine 160 to facilitate a transaction, according to the Rules interface 161, to be administered with the oversight of the Transaction Engine 150 to the Banking Interface 114. In another case, the Customer could defer payment by requesting the Billing Module 162 to send them the bill. Upon completion or deferment of payment, the Payment Module 510 tasking may be verified by Optimizer Module 166 and confirmed and archived in User Database 142 and/or Merchant Database 143, as the Rules Interface 161 determines, or may be electronically resubmitted to the Customer for completion, although not limited thereto.

The Customer may be invited to select Sub Module F. In this case, Sub Module F relates to Records Module 524. The Customer may be directed to acknowledge their directive to complete the administrative tasking specified in the Records Module 524 and complete the various tasks required by the Merchant or of their own interest, as the case may be. In the retail setting, the Customer may opt to have all of their purchases, receipts, preferences, clothing sizes, brand loyalty and other customer, product and/or service specific information aggregated and archived onto the Records Module 524 for future use, evaluation and/or dissemination. Upon completion, the Records Module 524 tasking may be verified by Optimizer Module 166 and confirmed and archived in User Database 142 and/or Merchant Database 143, as the Rules Interface 161 determines, or may be electronically resubmitted to the Customer for completion accuracy, as the case may be.

Finally, the Customer may be invited to Sub Module G. In this case, Sub Module G relates to Messaging Module 518. The Customer may be directed to acknowledge their directive to complete the administrative tasking specified in the Messaging Module 518 and complete the various tasks required by the Merchant or of their own interest, as the case may be. In the retail setting the Customer may be invited to a consumer research website, social network, Blog or any other communications forum to share, rank and/or rate their customer service experience, satisfaction with a product or service and/or participate in or provide any variety of interaction related to their preference, experiences, thoughts and/or feelings. The customer may be invited and/or inclined to send their Merchant or a different Merchant an e-mail or other communication relating a message or records transmission. Messaging Module 518 in cooperation with the SIDB 130 may allow the consumer to facilitate any type of communication via any communication method. Upon completion the Messaging Module 518 tasking may be verified by Optimizer Module 166 and confirmed and archived in User Database 142 and/or Merchant Database 143, as the Rules Interface 161 determines, or may be electronically resubmitted to the Customer for completion accuracy, as the case may be.

Throughout the customer's retail shopping experience and/or at the conclusion of the customers retail shopping experience the Customer may be invited to engage the Education Module 146 and/or the Entertainment Module 147 and their associated sub modules to gain personal, product and/or service-related education and/or enjoy their remaining time spent waiting for services to be delivered watching media content, reading media content or engaging in personal productivity functions such as e-mail or accessing their work related VPN, although not limited thereto. The Education Module 146 and Entertainment Module 147 may include any type or kind of sub module content conducive to the entertainment and pacification of a commerce initiator's time spent waiting for products and/or services to be provided. The Education Module 146 and Entertainment Module 147 may be interactive modules that allow the Customer and/or commerce initiator to interact with others on the Internet, blog sites, social networks, interactive gaming locations and interactive services and programs of the like. For instance, although not limited thereto, women waiting for their hair to set under a blow dryer at a beauty salon could access a fashion website or television show, people waiting for their automobile to be serviced could watch a football game and/or read an on-line magazine, and children at a salon could engage in remote, interactive gaming with one another as an optimized advantaged embodiment of the functionality of the electronic mobile commerce system 100 present teachings.

Throughout the Customer's interaction with the mobile appliance module 101 and associated interfaces 105, 106, 107 the Customer may view a timer located within the User Content 154 on the Graphic User Interface 300. As the products and/or services become available to the Customer the User Content 154 may display the navigator 158 interface that navigates the Customer, via GPS navigation and/or any other form of logistical tracking and positioning system, to where they may find the products and/or services. In the retail setting this could be the check-out stand, as an example.

During the Customer's interaction with the products and/or services the Merchant may have instantaneous access to the Customer's records and can update, modify, edit or add content and/or records to the Customer's record module 524 as the Merchant deems necessary, if permitted by the rules interface 161. Upon completion, the Records Module 524 tasking may be verified by Optimizer Module 166 and confirmed and archived in User Database 142 and/or Merchant Database 143, as the Rules Interface 161 determines, or may be electronically resubmitted to the Customer or Merchant for completion accuracy, as the case may be.

Upon completing their interaction with the Merchant, the Customer may sign off of their user interface 108 and corresponding account with the electronic mobile commerce system 100. The optimizer 166 may then be commissioned automatically to aggregate and document the billing associated with the Merchants, Customers and/or third parties share of paid content revenue, as governed by the rules interface 161, derived from the Customers' viewed and/or interacted paid content 154 during their interaction with the Merchant. The Optimizer 166 working in cooperation with the Paid Content Engine 154 may communicate the various parties' earned revenue share with the parties' respective account located within database 140 and associated account within the Omni SVA module 168 and/or affinity module 180, whatever the case may be. It may further communicate the accounting payable to the billing module 162 and the accounting receivable to the payment module 164. The paid content engine 154 in cooperation with billing module 162 may manage the accounts receivable for paid and/or interacted content from external content Merchants 126 and/or third party applications 128 through the banking interface 114. Working collaboratively with the optimizer 166 and payment module 164, according to the rules governed by the rules interface 161, it may facilitate payment of the parties' earned revenues to the parties respective stored value and/or currency accounts located within the electronic mobile commerce system 100 or to the parties' respective stored value and/or currency accounts located outside the electronic mobile commerce system 100 through the Banking Interface 114.

If the customer's Mobile Appliance Client Module 101 and associated display 105, 106 or 107 was rented or assigned by the merchant to the customer, the customer may then return it/them to the Mobile Appliance Check out Station 224 and, as illustrated in FIG. 6, the Tagged Client ID # may be released by the Merchants ERS 210 and Navigator Module 158 of the electronic mobile commerce system 101, in which case any associated deposits or collateral held by the Optimizer 166 and billing module 162 may be released and returned to the Customer, according to the rules established within the rules interface 161 of the electronic mobile commerce system 100.

It is to be understood that in practice the mobile appliance client module 101 and associated display 105, 106 or 107 of the preceding example is intended to illustrate the advantage of one embodiment of the present teachings for using the electronic mobile commerce system 100 to optimize the mechanisms for facilitating business processes, commerce and customer service within a retail setting. It is not limited to a merchant assigned or rented mobile appliance client modules 101 and an advantaged embodiment of the present teachings further includes the commerce initiator's utilization of a privately owned or privately rented mobile appliance client module 101 and associated display 105, 106, 107 that may be connected or connectable to an electronic mobile commerce system 100.

The customer, merchant and/or third party administrator may remotely access the electronic mobile commerce system 100 according to the access permitted by the customer, merchant and/or third party, governed by the rules interface 161 and optimizer module 166, to interact, interface and/or communicate with the modules and/or one another and/or others across the network through their respective interfaces according to the communications confidentiality rules established by each, and governed by the rules interface 161 of the electronic mobile commerce system 100.

By way of the preceding example, it is intended to illustrate the advantage of an embodiment of the present teachings, an optimization function using electronic mobile commerce system 100 to optimize the mechanisms for facilitating business processes, commerce and customer service within a retail setting.

The advantaged illustration demonstrates streamlined administrative processing and logistical navigation which may be facilitated exclusively and autonomously by the Customer or commerce initiator, to the exclusion of utilizing the merchant's administrative or manpower resources to expedite administration and navigate the Customer to the whereabouts of products and/or services.

The advantaged illustration further demonstrates streamlined communications and commerce which may facilitate comprehensive security, authentication, tracking, data input, administrative tasking, confirmation of system accuracy, system coordination and optimization of records storage, automated direct and Third party communications, automated accounting, automated revenue generation as well as automated commerce transaction management and further may eliminate redundant utilization of manpower and tasking, saving the customer time and the merchant expense, although not limited thereto.

The advantaged illustration further demonstrates enhanced customer services and collaborative revenue generation methods benefiting all parties in the forms of Customer/commerce initiator-directed processing and fulfillment of administrative tasking, preservation of administrative work product to the access and benefit of all parties, interactive education and interactive entertainment to the benefit of all parties and the associated business process. It further demonstrates management of time and expectations to the benefit of all parties, passive revenue generation and interactive revenue generation programs to the benefit and good fortune of all parties, and facilitation of affinity programs and stored value accounts to the benefit and good fortune of all parties.

According to an embodiment of the present teachings, an optimization function may be used by the electronic mobile commerce system 100 to optimize the mechanisms for facilitating business processes, commerce and customer service at a location-based enterprise. By way of example, for instance, using the electronic mobile commerce system 100 of the present teachings, a commerce initiator soliciting services at a retail merchant facility such as a restaurant could, upon arrival to the restaurant, with their Mobile Appliance Client Module 101 and related Display 105, 106 or 107 in hand, “Sniff” or be “sniffed” by the Merchant's wireless network. The process of “Sniff” or “Sniffing” is an application known by those familiar in the art, wherein the commerce initiators Mobile Appliance Client Module 101 is recognized by the Merchant's wireless network, commonly known as the “Wi-Fi” network, although not limited thereto.

The commerce initiator's Mobile Appliance Client Module 101 and related Display 105, 106 or 107 may be asked to join the network and/or join the network automatically. The network may be merchant-owned or public, although not limited thereto. The commerce initiator, or ‘Customer’ for this example, may then view their Mobile Appliance Client Module 101 and related Display 105, 106 or 107 to see and/or locate the Merchant and/or third party content on their display's Graphic User Interface 300 to see the Paid Content 154 along with the User Content 320. The Paid Content 154 may remain active and constant throughout the customer's interaction with various content modules, generating paid content revenue on behalf of the Merchant and/or customer and/or Third Party, depending on the rules and permissions assigned to the Electronic Mobile Commerce System 100, as the case may be. It is to be understood that in practice customization of the rules interface module 161 by the merchant and/or third party through their respective merchant interface 110 and/or TPA interface 112 may dictate whether, and/or at what point in the customer's interaction, customers may view or derive revenue from the paid content 154.

As illustrated in FIG. 7 the Customer may then be welcomed 702 to the merchant's facility. The welcome may include a personal introduction, in the form of a letter, image, audio clip, video clip or media presentation administered by the Merchant's interface 110 with their merchant database 143 located within the database 140 further contained within the SIDB 130 of the electronic mobile commerce system 100, although not limited thereto. If the Customer is a First Time User 704 it may facilitate the First Time User Set up Process 706, as illustrated in FIG. 8.

According to exemplary FIG. 7, if the system architecture 718 is OPEN the Customer may advance to the Universal Commands 728, as illustrated in FIG. 10, to facilitate the customer's desired dining experience. Now following FIG. 10 and using FIG. 5 as detailed reference, the Customer may select Menu Module 502 of the Administration Module 145. The Customer may reference and interact with a menu or list of the merchant's products and/or services. The Customer may select any individual or a plurality of menu items or services they desire to purchase, learn more about and/or specify their preferences for specific menu items to be prepared according to their taste and desires, as the case may be. Upon completion the Menu Module 502 tasking may be verified by Optimizer Module 166 and confirmed and archived in User Database 142 and/or Merchant Database 143, as the Rules Interface 161 determines, or may be electronically resubmitted to the Customer for completion accuracy, as the case may be.

The Customer may then select Sub Module B. In this case, Sub Module B relates to Ordering SKU Module 506. The Customer may then verify the menu items they wish to purchase, learn more about and/or customize. The Ordering SKU Module 506, in collaboration with Merchant Database 143 and Optimizer 166, may provide the customer with a menu item's and/or service's relevant ordering information such as its ordering or part number, price, costs of customization, confirmation of customizations, affinity incentives and any specific information relevant to the purchase and tracking of the menu item and/or service. The Ordering SKU Module 506, in collaboration with Merchant Database 143 and Navigator 158, may further provide the customer logistical information related to the preparation and/or customization of said selected menu items and/or services that enable the customer to autonomously monitor and track said menu items and/or services as they are being prepared. Accordingly, the Ordering SKU module 506 may be logic capable. It may be optimized by the Optimizer 166 and Translator 153 to accommodate whatever menu item discovery requests or customizations the customer may have related to specific menu items and/or services. In this way customer service and education may be optimized by the electronic mobile commerce system 100. Upon completion the Ordering SKU Module 506 tasking may be verified by Optimizer Module 166 and confirmed and archived in User Database 142 and/or Merchant Database 143, as the Rules Interface 161 determines, or may be electronically resubmitted to the Customer for completion accuracy, as the case may be.

According to the customer's menu item discovery request, customization request and/or purchase request the Optimizer Module 166, working collaboratively with the Translator Module 153, may invite the customer to view those modules specific to their stated product discovery request, customization request and/or modules related to their purchase request.

The Customer may then select the Education Model 146, wherein they select Sub Module A. In this case, Sub Module A relates to the Info & FAQ module 530. The Customer may then query the Info & FAQ Module 530 for information content specific to their desired menu items and/or services. In this case, the customer may desire to evaluate the ingredients, nutritional aspects, customization options or any variety of questions, requests, preference issues or concerns they may have about certain menu items.

The Customer may then select Sub Module B. In this case, Sub Module B relates to the Video/Image module 534. The Customer may then query the Video/Image module 534 for videos and images specific to their desired menu items and/or services. In this case, the customer could view particular menu items to learn about their appearance, proportions, textures, customization options or any other preparation or evaluation metric they may seek.

The Customer may then select Sub Module C. In this case, Sub Module C relates to the Interactivity module 540. The Customer may then query their social network and/or evaluate information specific to the desired menu item or service, such as customization options, customer testimonials, restaurant ratings, menu item ratings, ingredients, nutritional information and/or any other preparation and/or evaluation metric they may seek.

The customer may then return to the Administration Module and select Sub Module C. Sub Module C, in this case, relates to the Billing Module 514. Billing Module 514 may work in coordination with Ordering SKU Module 506, Optimizer 166 and Billing Module 162 of the Commerce Engine to complete the order of the customer's desired menu item and/or services.

The customer may then be invited to view Sub Module D. In this case, Sub Module D relates to Affinity Module 526. The Customer may be directed to acknowledge their directive to complete the administrative tasking specified in the Affinity Module 526 and complete the various tasks required by the Merchant, as the case may be. In this case, the Customer may enroll in a merchant-specific affinity account such as a Dining Rewards Program, culinary society or any other variety of affinity program the customer and/or merchant may be associated with or aspire to become associated with. In the event that the customer is already associated with an affinity program the customer may opt to have the affinity module 526 coordinate administration of any relevant affinity with the Affinity Module 180, as overseen by the Rules interface 161 and further optimized by the Optimizer 166, directing some or all of their share of earned revenues, derived from their viewing of paid content 154, to be stored in the Omni SVA 168 and/or deposited in a designated deposit account through the Banking Interface 114. Upon completion the Affinity Module 526 tasking may be verified by Optimizer Module 166 and confirmed and archived in User Database 142 and/or Merchant Database 143, as the Rules Interface 161 determines, or may be electronically resubmitted to the Customer for completion accuracy, as the case may be.

The customer may be directed to Sub Module E which, in this case, relates to the Payment Module 510. The Customer may be directed to acknowledge their directive to complete the administrative tasking specified in the Payment Module 510 and complete the various tasks required by the Merchant, as the case may be. In this case, the Customer may be requested to verify their order, add their tip for services and pay their bill. In which case, the Customer could facilitate payment to the Merchant by authorizing Payment Module 164 of the Commerce Engine 160 to facilitate a transaction, according to the Rules interface 161, to be administered with the oversight of the Transaction Engine 150 to the Banking Interface 114. In another case, the Customer could defer payment by requesting the Billing Module 162 to send them the bill. Upon completion or deferment of payment the Payment Module 510 tasking may be verified by Optimizer Module 166 and confirmed and archived in User Database 142 and/or Merchant Database 143, as the Rules Interface 161 determines.

The Customer may then be invited to select Sub Module F. In this case, Sub Module F relates to Records Module 524. The Customer may be directed to acknowledge their directive to complete the administrative tasking specified in the Records Module 524 and complete the various tasks required by the Merchant or of their own interest, as the case may be. In the restaurant setting, the Customer may opt to have all of their purchases, receipts, preferences, customizations, restaurant menus, ordering information such as the restaurant's Take Out menu and phone number, and other customer, menu and/or service specific information aggregated and archived into the Records Module 524 for future use, evaluation and/or dissemination. Upon completion, the Records Module 524 tasking may be verified by Optimizer Module 166 and confirmed and archived in User Database 142 and/or Merchant Database 143, as the Rules Interface 161 determines, or may be electronically resubmitted to the Customer for completion accuracy, as the case may be.

Finally, the Customer may be invited to Sub Module G. In this case, Sub Module G relates to Messaging Module 518. The Customer may be directed to acknowledge their directive to complete the administrative tasking specified in the Messaging Module 518 and complete the various tasks required by the Merchant or of their own interest, as the case may be. In the restaurant setting, the Customer may be invited to a consumer research website, social network, Blog or any other communications forum to share, rank and/or rate their customer service experience, customization preferences, ideas, satisfaction with a menu item or restaurant's service and/or participate in, or provide, any variety of interaction related to their customizations, preference, experiences, thoughts and/or feelings. The customer may be invited and/or inclined to send their Merchant or a different Merchant an e-mail or other communication relating a message or records transmission. Messaging Module 518 in cooperation with the SIDB 130 may allow the consumer to facilitate any type of communication via any communication method. Upon completion the Messaging Module 518 tasking may be verified by Optimizer Module 166 and confirmed and archived in User Database 142 and/or Merchant Database 143, as the Rules Interface 161 determines, or may be electronically resubmitted to the Customer for completion accuracy, as the case may be.

Throughout the customer's dining experience and/or at the conclusion of the customer's dining experience the Customer may be invited to engage the Education Module 146 and/or the Entertainment Module 147 and their associated sub modules to gain personal, product and/or service-related education and/or enjoy their remaining time spent waiting for services to be delivered watching media content, reading media content or engaging in personal productivity functions such as e-mail or accessing their work-related VPN. The Education Module 146 and Entertainment Module 147 may include any type or kind of sub module content conducive to the entertainment and pacification of a commerce initiator's time spent waiting for products and/or services to be provided. The Education Module 146 and Entertainment Module 147 may be interactive modules that allow the Customer and/or commerce initiator to interact with others on the Internet, blog sites, social networks, interactive gaming locations and interactive services and programs of the like. For instance, while waiting for their meal to be served, diners could review restaurant ratings, view cooking shows or interactive media content produced by the restaurant, play an interactive game with one another across the table or across the country, conduct interactive dialogue with the chef, waiter or wine sommelier, or conduct a personal search for a variety of content as an optimized advantaged embodiment of the functionality of the electronic mobile commerce system 100, although not limited thereto.

Throughout the Customer's interaction with the mobile appliance module 101 and associated interfaces 105, 106, 107 the Customer may view a timer located within the User Content 154 on the Graphic User Interface 300. As the menu items are being prepared and become available to the Customer the User Content 154 may display the navigator 158 interface that navigates the Customer, via GPS navigation and/or any other form of logistical tracking and positioning system, to where they may find the menu items and/or services, or may simply advise the diners that their meal is being delivered. In the restaurant setting, for example, this could be to alert the diners to return to their table and/or to prepare for the arrival of their meal.

During the Customer's interaction with the menu and/or restaurant services, the Merchant may have instantaneous access to the Customer's order and communicate electronically with the customer to confirm, verify, update, modify, edit or add menu related questions, directives, content and/or records to the Customer's Menu module 504, order module 506 and record module 524, as the Merchant deems necessary, if permitted by the rules interface 161. Upon completion, the Menu module 504, order module 506 and Records Module 524 tasking may be verified by Optimizer Module 166 and confirmed and archived in User Database 142 and/or Merchant Database 143, as the Rules Interface 161 determines, or may be electronically resubmitted to the Customer or Merchant for completion accuracy, as the case may be.

Upon completing an interaction with the Merchant, the Customer may sign off of their user interface 108 and corresponding account with the electronic mobile commerce system 100. The optimizer 166 may then be commissioned automatically to aggregate and document the billing associated with the Merchant's, Customer's and/or third party's share of paid content revenue, as governed by the rules interface 161, derived from the Customer's viewed and/or interacted paid content 154 during their interaction with the Merchant. The Optimizer 166, working in cooperation with the Paid Content Engine 154, may communicate the various parties' earned revenue share with the parties' respective account located within database 140 and associated account within the Omni SVA module 168 and/or affinity module 180, whatever the case may be. It may further communicate the accounting payable to the billing module 162 and the accounting receivable to the payment module 164. The paid content engine 154, in cooperation with billing module 162, may manage the accounts receivable for paid and/or interacted content from external content Merchants 126 and/or third party applications 128 through the banking interface 114. Working collaboratively with the optimizer 166 and payment module 164, according to the rules governed by the rules interface 161, it may facilitate payment of the parties' earned revenues to the parties' respective stored value and/or currency accounts located within the electronic mobile commerce system 100 or to the parties' respective stored value and/or currency accounts located outside the electronic mobile commerce system 100 through the Banking Interface 114.

If the customer's Mobile Appliance Client Module 101 and associated display 105, 106 or 107 was rented or assigned by the merchant to the customer, the customer may then return it/them to the Mobile Appliance Check out Station 224 and, as illustrated in FIG. 6, the Tagged Client ID # may be released by the Merchant's ERS 210 and Navigator Module 158 of the electronic mobile commerce system 101 and any associated deposits or collateral held by the Optimizer 166 and billing module 162 may be released and returned to the Customer, according to the rules established within the rules interface 161 of the electronic mobile commerce system 100.

It is to be understood that in practice the mobile appliance client module 101 and associated display 105, 106 or 107 of the preceding example are intended to illustrate advantages of one embodiment of the present teachings to optimize the mechanisms for facilitating business processes, commerce and customer service within a restaurant setting. The present teachings are not limited to merchant assigned or rented mobile appliance client modules 101 and an advantaged embodiment of the present present teachings may further include the commerce initiator's utilization of privately owned or privately rented mobile appliance client module 101 and associated display 105, 106, 107 that may be connected or connectable to an electronic mobile commerce system 100, although not limited thereto.

The customer, merchant and/or third party administrator may remotely access the electronic mobile commerce system 100 according to the access permitted by the customer, merchant and/or third party, governed by the rules interface 161 and optimizer module 166. This may permit them to interact, interface and/or communicate with the modules and/or one another and/or others across the network through their respective interfaces according to the communications confidentiality rules established by each, and governed by the rules interface 161 of the electronic mobile commerce system 100.

By way of the preceding example it is intended to illustrate advantages of one embodiment of the present teachings to optimize the mechanisms for facilitating business processes, commerce and customer service within a restaurant setting.

The advantaged illustration demonstrates streamlined order processing and logistical navigation, which may be facilitated exclusively and autonomously by the Customer or commerce initiator, to the exclusion of utilizing the merchant's administrative or manpower resources to expedite ordering, order customization, navigating the Customer to the whereabouts of menu items and/or services, and communicating the preparation and delivery schedule of menu items and/or services.

The advantaged illustration further demonstrates streamlined communications and commerce that facilitated order input, order customization, administrative tasking, confirmation of order accuracy, system coordination and optimization, along with records storage, automated communications, automated accounting, automated revenue generation as well as automated commerce transaction management, and further eliminates redundant utilization of manpower and tasking, saving the customer time and the merchant expense, although not limited thereto.

The advantaged illustration further demonstrates enhanced customer services and collaborative revenue generation methods benefiting all parties in the forms of Customer/commerce initiator-directed processing and fulfillment of administrative tasking, preservation of administrative work product to the access and benefit of all parties, interactive education and interactive entertainment to the benefit of all parties and the associated business process. It further demonstrates management of time and expectations to the benefit of all parties, passive revenue generation and interactive revenue generation programs to the benefit and good fortune of all parties, and the facilitation of affinity programs and stored value accounts to the benefit and good fortune of all parties.

As described above, FIGS. 1, 2, 3, 4 and 5 show embodiments of the system of the present teachings. Further, FIGS. 6, 7, 8, 9, 10, 11 and 12 show various steps in accordance with one embodiment of the present teachings. The processing components that make up the system of the present teachings may each be in the form of a “processing machine,” such as a general purpose computer, for example. As used herein, the term “processing machine” is to be understood to include at least one processor that uses at least one memory. The at least one memory may store a set of instructions. The instructions may be permanently or temporarily stored in the memory or memories of the processing machine. The processor may execute the instructions that are stored in the memory or memories in order to process data. The set of instructions may include various instructions that perform a particular task or tasks. Such a set of instructions for performing a particular task may be characterized as a program, software program, or simply software, although not limited thereto.

As noted above, the processing machines may execute the instructions that are stored in the memory or memories to process data. This processing of data may be in response to commands by a user or users of the processing machine, in response to previous processing, in response to a request by another processing machine and/or any other input, although not limited thereto.

As noted above, the processing machine used to implement the present teachings may be a general purpose computer. However, the processing machine described above may also utilize any of a wide variety of other technologies including a special purpose computer, a computer system including a microcomputer, minicomputer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the present teachings.

It is appreciated that in order to practice the method of the present teachings as described above, it is not necessary that the processors and/or the memories of the processing machine be physically located in the same geographical place. That is, each of the processors and the memories used in the present teachings may be located in geographically distinct locations and connected so as to communicate in any suitable manner. Additionally, it is appreciated that each of the processor and/or the memory may be composed of different physical pieces of equipment. Accordingly, it is not necessary that a particular processor be one single piece of equipment in one location and that a particular memory be another single piece of equipment in another location. That is, it is contemplated that a processor may also be two or more pieces of equipment in two different physical locations, although not limited thereto. The two distinct pieces of equipment may be connected in any suitable manner. Additionally, a particular memory may include two or more portions of memory in two or more physical locations.

To explain further, processing performed by the optimizer 166 and the other portions as described above is performed by various components and various memories. However, it is appreciated that the processing performed by two distinct components as described above may, in accordance with a further embodiment of the present teachings, be performed by a single component. Further, the processing performed by one distinct component as described above may be performed by two or more distinct components. In a similar manner, the memory storage performed by two distinct memory portions as described above may, in accordance with a further embodiment of the present teachings, be performed by a single memory portion. Further, the memory storage performed by one distinct memory portion as described above might be performed by two or more memory portions.

Further, various technologies may be used to provide communication between the various processors and/or memories, as well as to allow the processors and/or the memories of the present teachings to communicate with any other entity, e.g., so as to obtain further instructions or to access and use remote memory stores. Technologies used to provide such communication might include a network such as the Internet, an Intranet, Extranet, LAN, WAN, WIS, Ethernet, or any system that provides communication. In addition, any of the communication techniques described above may use any suitable protocol such as TCP/IP, UDP, OSL, WAP, SMS, for example.

As described above, a set of respective instructions may be used in the processing performed by a particular component in the electronic mobile commerce system 100. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software may tell the particular processing machine what to do with data being processed.

Further, it is appreciated that the instructions or set of instructions used in the implementation and operation of the present teachings may be in a suitable form such that the processing machine may read the instructions. For example, the instructions that form a program may be in the form of a suitable programming language, which may be converted to machine language or object code to allow the processor or processors to read the instructions. That is, written lines of programming code or source code, in a particular programming language, may be converted to machine language using a compiler, assembler or interpreter. In one embodiment, the machine language may be binary coded machine instructions that are specific to a particular type of processing machine, e.g., to a particular type of computer. The computer may understand the machine language.

Any suitable programming language may be used in accordance with the various embodiments of the present teachings. Illustratively, the programming language used may include assembly language, ADA, APL, Basic, C, C++, COBOL, dBase, Forth, Fortran, Java, Modula-2, Pascal, Prolog, REXX, Visual Basic, and/or JavaScript, for example.

Further, it is not necessary that a single type of instructions or single programming language be utilized in conjunction with the operation of the systems and methods of the present teachings. Rather, any number of different programming languages may be utilized as is necessary or desirable. Also, the instructions and/or data used in the practice of the present teachings may utilize any compression or encryption technique or algorithm, as may be desired.

As described above, the present teachings may illustratively be embodied in the form of a processing machine, including a computer or computer system, for example, that may include at least one memory. It is to be appreciated that the set of instructions, e.g., the software that enables the computer operating system to perform the operations described above, may be contained on any of a wide variety of media or medium, as desired. Further, the data that is processed by the set of instructions might also be contained on any of a wide variety of media or medium. That is, the particular medium, e.g., the memory in the processing machine, may be utilized to hold the set of instructions and/or the data used in the present teachings may take on any of a variety of physical forms or transmissions. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, cable, or fiber communications channel, a satellite transmissions or other remote transmission, as well as any other medium or source of data that may be read by the processors of the present teachings.

Further, the memory or memories used in the processing components that implement the present teachings may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example, as well as those arrangements described above.

In the systems and methods of the present teachings, a variety of “user interfaces” may be utilized to allow a user to interface with the processing machine that is used to implement the present teachings, e.g., such as the user interface 108 and the banking & finance interface 114. As used herein, a user interface includes any hardware, software, or combination of hardware and software used by the processing machine that allows a user to interact with the processing machine. A user interface may be in the form of a dialogue screen for example. A user interface may also include any of a touch screen, keyboard, mouse, voice reader, voice recognizer, dialogue screen, menu box, a list, a checkbox, a toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface may be utilized by the processing machine that performs a set of instructions such that the processing machine processes data for a user. The user interface is typically used by the processing machine for interacting with a user to convey information or receive information from the user. However, it should be appreciated that in accordance with some embodiments of the systems and methods of the present teachings, it is not necessary that a human user actually interact with a user interface used by the processing machine of the present teachings. Rather, it is contemplated that the user interface of the present teachings might interact, e.g., convey and receive information, with another processing machine, rather than a human user. Accordingly, the other processing machine might be characterized as a user. Further, it is contemplated that a user interface utilized in the systems and methods of the present teachings may interact partially with another processing machine or processing machines, while also interacting partially with a human user.

Accordingly, the foregoing description of the systems and methods of the present teachings is illustrative. For instance, as shown in FIG. 1, while one embodiment of the present teachings has generally been described in terms of a processor 124 managing the optimization of transactions over a network 118, in other embodiments the processor 102 or other intelligent device may be self-contained, for instance in a desktop machine, for instance running a so-called fat client.

In other embodiments with further reference to FIG. 1, an input interface to the commerce initiator may be by way of a telephone or mobile cellular telephone connection, for instance via a call center facility or a voice response unit (VRU) enabled to communicate with data storage 140 or other elements. Yet further, while the present teachings have generally been described in terms of coordinated transactions in which the presented bill, payment source and payee all deal in the same currency and/or stored value, in other embodiments currency and/or stored value conversions may be performed at various stages of the transaction and/or according to the users defined rules, governed by the rules interface 161. Transactions may be enacted in the forms of different currency or in exchange for redemption of stored values against currency or vice versa. Yet further, while the present teachings have generally been described in terms of electronic fulfillment of coordinated transactions, check or other hard copy or other types of payment may be optimized and delivered according to the present teachings.

Accordingly, it will be readily understood by those persons skilled in the art that the present teachings optimize electronic mobile commerce systems and methods to better enable location-based merchants to automate business administration tasking, commerce transaction management and customer service, among other tasks. The electronic mobile commerce system of the present teachings may securely authenticate, admit, process, profile, aggregate and archive information inputted directly by the client at the merchant's physical or virtual place of business, or in advance of the client's arrival to the merchant's place of business. The electronic mobile commerce system of the present teachings further automates and expedites the merchant's administrative and data processing, authenticates the user's identity, automates documentation processing, streamlines commerce transaction management, automates accounting and finance functions, facilitates autonomous navigation on behalf of the user in navigating about a facility and/or locating products and services, allows the client to monitor relevant waiting times for products or services to be delivered, provides the client with educational tools and interactive information to optimize their product discovery and service, provides the client with entertainment and interactive activities to pacify the client while they wait for products and/or services to be delivered, integrates a location-based merchant's front end office applications with the merchant's back end operational systems to optimize business administration and expedite service, and further generates revenues on behalf of the merchant, client and third party derived from the user's viewing and interaction with paid content concurrent to their viewing and interaction with the business administration processing, commerce transaction and customer service content described.

The present teachings comprise a system and method of delivering electronic user applications and interactive user content and tracking systems along with paid content to a mobile appliance at a merchant's place of business. This has the intention of generating revenues derived from the commerce initiator viewing paid content during their interaction with the user applications, interactive user content and the tracking systems described herein.

Accordingly, it will be readily understood by those persons skilled in the art that the present teachings are susceptible to broad utility and application. Many embodiments and adaptations of the present teachings other than those herein described, as well as many variations, modifications and equivalent arrangements, will be apparent from or reasonably suggested by the present teachings and foregoing description thereof, without departing from the substance or scope of the present teachings.

Accordingly, while the present teachings have been described here in detail in relation to its exemplary embodiments, it is to be understood that this disclosure is only illustrative and exemplary of the present teachings and is made to provide an enabling disclosure of the present teachings. Accordingly, the foregoing disclosure is not intended to be construed or to limit the present teachings or otherwise to exclude any other such embodiments, adaptations, variations, modifications and equivalent arrangements.

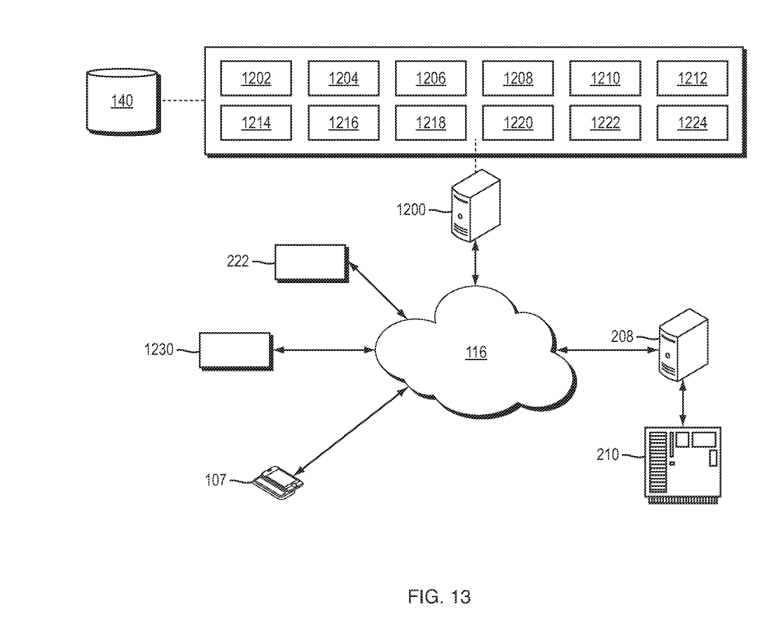

Referring now to FIG. 13, shown is a simplified exemplary diagram of the systems depicted in FIGS. 1-5 and which enables the flowcharts depicted in FIGS. 6-12. A system for providing information and services through a mobile device to a customer of a business may comprise a provider server 1200, a business server 208 and a mobile device 107, although not limited thereto, all of which may communicate with each other over a network 116. The system may also comprise a kiosk where the customer can rent or borrow the mobile device 107 during the customer's visit to a location-based business, although not limited thereto. In this way, when the customer rents or borrows the mobile device 107, it may be associated with customer information stored on the provider server 1200 or business server 208, although not limited thereto.

The network 116 may comprise a single network, such as the Internet, or a number of different networks and communication may be either wired or wireless, although not limited thereto. In one embodiment, the mobile device 107 may communicate to the provider server 1200 using at least in part the same network as the provider server 1200 uses to communicate with the business server 208. It may be preferable in certain embodiments that the communications over the networks be secure. For example, the mobile device 107 may communicate securely with the provider server 1200. In addition, the business server 208 (or some other device including an integration broker 152) may be adapted for setting up secure link with the provider server 1200 so that the provider server 1200 and any hardware located at the business (e.g., business server 208) may communicate securely with each other.

The provider server 1200 may communicate with a database 140 (e.g., data storage), and may have information related to products and/or services of the business, which may be a location-based business, although not limited thereto. Such information may include menus, forms, product/service information, business rewards programs, and customer service information (e.g., satisfaction surveys, etc.), although not limited thereto. Any information may be provided to a user (e.g., customer, prospective customer, etc.) through the mobile device 107. The provider server 1200 may be located remotely from the business and accessible over a network 116 from the business. In one embodiment, although not limited thereto, the provider server 1200 may be under the physical control of a third party service provider. In this way, the service provider may manage the provider service as a service for location-based businesses (e.g., “cloud” service, software-as-a-service, etc.).

The provider server may have a customer profile for the customer, which the customer may modify through mobile device 107 or some other interface, although not limited thereto. For example, the system may further comprise a website 1230 for the customer to access information on the provider server 1200 through a web browser from a personal computer, although not limited thereto. In the medical setting, a customer profile may be a patient record stored on the provider server 1200 which the patient can manage and “own.” In addition, the medical provider, or any number of medical providers, may be able to access and edit the patient's record, or their own version or versions of the patient's record, which may be stored and managed by a third party service provider, although not limited thereto. In one embodiment, the customer profile may comprise customer billing information. By communicating with the business server 208, the information such as the customer profile stored on the provider server 1200 may synchronize with the business' back-office data so that any changes made on the provider server 1200 are communicated to the business.

A business server 208 may be located at the business and communicate with the provider server over a network 116. The business server 208 may incorporate an integration broker 152 or the functionality thereof, although not limited thereto. The business server 208 may have information related to back-office operations of the business, including customer information for the customer, which may be stored in business management software 210 (e.g., ERS, business database, etc.), although not limited thereto. Customer information may include past customer transaction information, for example, which may be provided to the customer through the mobile device 107 by the provider server 1200. In one embodiment, at least a portion of the business server 208 (or business management software 210) may be backed-up over the network 116 to the provider server 1200 for offsite backup.

Using a system so described, when the customer is at or near the geographic location of the business, the customer may be provided access to relevant information on the provider server 1200 through the mobile device 107. The relevancy of the provided information may be determined at least in part by the customer information. In one example, if a customer is known (e.g., stored in customer information, etc.) to be looking for a large screen television to purchase and there is a sale on such items at the business, the sales information may be provided to the customer through the mobile device 107 upon arriving at the business.

The provider server 1200 may have a number of pieces of software executing on computer readable medium. Management software 1202 executing on a computer readable may manage the information in the provider server by an agent of the business. In this way, a business employee may determine what information will be accessible by customers through the mobile device 107. Authentication software 1204 executing on a computer readable medium may authenticate the mobile device 107 based at least in part on the proximity of the mobile device 107 to the geographic location of the business. Authentication software 1204 may also comprise asking the customer for a username/password combination and/or a biometric identifier.

Mobile interface software 1206 executing on a computer readable medium may provide information from the provider server 1200 (e.g., stored in database 140, etc.) to the customer wirelessly through the mobile device 107 and may receive data input from the customer through the mobile device 107. The mobile interface software 1206 may provide the customer the ability to access a customer profile, information on the business' products or services, or any other content provided by the provider server 1200 or otherwise accessible over the network 116. For example, the mobile interface software 1206 may provide the customer with information on a business rewards program for the business through the mobile device 107.

Task completion software 1208 executing on a computer readable medium may provide the customer the ability to complete a number of tasks relating to the business or the customer's visit to the business. Information about the task may be communicated from the provider server 1200 to the business server 208.

The business in one embodiment may be a location-based business, although not limited thereto. For example, the business may be a medical facility, the customer may be a patient, and the mobile interface software 1206 may provide access to electronic forms related to a doctor appointment. In another embodiment, the business may be a restaurant and the mobile interface software 1206 may provide access to an electronic menu. In such a way, one task the customer may perform may be ordering a menu item from the restaurant. In still a further embodiment, the business may be a store and the mobile interface software 1206 may provide access to information related to products offered by the store. In such a way, one task the customer may perform may be ordering a product and/or service from the business. If the business is a location-based business, it may be preferable for the system to welcome the customer upon arrival at the geographic location of the location-based business through the mobile device. The customer may also track the progress of any ordered product and/order service through the mobile device 107. In still other embodiments, the business may not be location-based but may instead be a travelling medical provider or a food delivery service, although not limited thereto.

In another embodiment, the business may be a restaurant and the mobile interface software 1206 may provide access to an electronic menu. In such a way, one task the customer may perform may be ordering a menu item from the restaurant. Employing administration features, the customer may customize an order. Another task the customer may perform may be viewing an interactive video of the menu item being prepared. Employing education features, the customer may learn about the ingredients and nutritional content of the menu items, the origins of the menu items, the manufacturers of the menu items and the food preparation methods of the menu item, although not limited thereto. An additional task the customer may perform may be to interact with an entertainment feature and/or a paid content wrapper to receive informational regarding entertainment opportunities in the vicinity of the restaurant and/or to purchase tickets to events and/or make reservations to attend entertainment venues after their meal, although not limited thereto. Employing an entertainment feature, the user of the electronic menu can optimize the dining and post-dining entertainment experience and opportunities, although not limited thereto. The restaurant may also earn rebates from local merchants on the entertainment services that are purchased by their customers and the advertising content that is viewed on the electronic menu.

Other tasks which may be completed by the customer may include filling out a form or forms (e.g., medical forms in the medical setting, etc.) for providing information to the business to assist the business in serving the customer. In this way, data in the form or forms may be transmitted to the business server 208 to automate data entry for the business. Another task may include scheduling an appointment (e.g., doctor appointment in medical setting). Another task may include initiating payment for a good and/or service provided by the business. In one embodiment, although not limited thereto, the provider server 1200 may settle payment and communicate payment to the business server 208. Still another task may be alerting a location-based business to the customer's presence at the geographic location of the location-based business. Still another task may comprise filling out a customer service survey offered to the customer, where the survey relates to the customer's visit to or transaction with the business.

The provider server 1200 may further comprise navigation software 1210 executing on a computer readable medium for navigating a customer to a product and/or service provider located at a location-based business based. The product and/or service the customer is navigated to may be identified by a customer inquiry made through the mobile device or may be a predetermined product or service determined at least in part by the customer information, although not limited thereto. Navigation may be supported through the use of a GPS locator in the mobile device 107. This way, the user may be navigated to particular locations or products, although not limited thereto. Products may have RFIID tags to assist the user in locating and/or navigating to the products. The mobile device 107 may also have an RFIID tag reader or bar code reader, although not limited thereto, in order to identify products so that the user may then request additional information on the products.

The provider server 1200 may have administration software 1212 executing on a computer readable medium for alerting the business to the customer's presence. The administration software 1212 may also provide the customer a time estimate until the customer will be helped by an agent of the business. The administration software 1212 may also provide customer information to the customer through the mobile device 107. The administration software 1212 may also admit and/or process a customer (e.g., a patient in the medical setting) for an appointment.

The provider server 1200 may have education software 1214 executing on a computer readable medium for providing, through the mobile device, educational information related to the business' products and/or services.

The provider server 1200 may have advertising software 1216 executing on a computer readable medium for providing directed advertising to the customer, through the mobile device, based at least on the type of business and/or the information the customer is viewing through the mobile device 107. The advertising software 1216 may comprise a content wrapper (as shown in FIGS. 3-5). Revenue generated by the advertising software 1216 may be shared by the customer and the business, the customer and the service provider, the service provider and business, or any combination thereof, although not limited thereto. In the medical setting a customer's share of revenue may fund a medical savings account. In an alternative, the customer's share of revenue may be redeemed for cash, services, or products, although not limited thereto.

The provider server 1200 may have entertainment software 1218 executing on a computer readable medium for providing, through the mobile device, entertainment to the customer while the customer waits until the customer is helped by an agent of the business.

The provider server 1200 may have reporting software 1220 executing on a computer readable medium for providing information on revenue generated by the advertising software 1216. This way, both the customer and the business, although not limited thereto, can see how much revenue has been generated by the customer's viewing/interacting with content through the mobile device 107, as well as each party's share of the revenues.

The provider server 1200 may have social network software 1222 executing on a computer readable medium for the customer to interact with other customers to share information. This may allow the customer to access content and interact with others through the mobile device 107. In addition, social network software 1222 may permit the medical provider to interact with further medical providers to share information regarding patent care, although not limited thereto. In fact, the social network software 1222 may provide the ability to any user on the system to interact with any other user, which may be performed securely, although not limited thereto.

The provider server 1200 may have messaging software 1224 executing on a computer readable medium for the customer to securely message the business. In one example, although not limited thereto, it may be preferable to allow a patient to securely communicate with a medical provider (e.g., doctor).

A method according to the present teachings may comprise, although not limited thereto: providing a provider server having information related to the goods and/or services of the location-based business, the provider server accessible over a network from the location-based business; providing management software executing on a computer readable medium for managing the information on the provider server by an agent of the medical provider; providing authentication software executing on a computer readable medium for authenticating a mobile device based at least in part on the proximity of the mobile device to the medical provider; providing mobile interface software executing on a computer readable medium for providing the information from the provider server to a customer of the location-based business through the mobile device and for receiving data input from the customer wirelessly through the mobile device; and providing a business server having information related to back-office operations of the location-based business including customer information for the customer, the business server located at the location-based business and adapted to communicate with the provider server; wherein the customer may complete a task related to a visit to the location-based business through the mobile device, and information about the task is communicated from the provider server to the business server.

The method may further comprise the step of providing education software executing on a computer readable medium. Education software may provide, through the mobile device, educational information related to the customer's visit to the location-based business. The education software may comprise the steps of semantically illustrating anatomy, physiology, pathology, and treatment options, although not limited thereto. For example, in the medical provider environment the education software may be able to help a patient to learn about a diagnosis (e.g., differential diagnosis, etc.) which may help ease anxiety, although not limited thereto.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system for providing information and services through a mobile device to a customer of a location-based business, comprising:
a provider server having information related to products and/or services of the location-based business, the provider server accessible over a network from the location-based business;
management software executing on a computer readable medium for managing the information in the provider server by an agent of the location-based business;
authentication software executing on a computer readable medium for authenticating the mobile device based at least in part on the proximity of the mobile device to the geographic location of the location-based business;
mobile interface software executing on a computer readable medium for providing the information from the provider server to the customer wirelessly through the mobile device and for receiving data input from the customer through the mobile device;
wherein the provider server communicates over a network with a business server, the business server located at the location-based business and having information related to back-office operations of the location-based business including customer information for the customer;
when the customer is at or near the geographic location of the location-based business the customer is provided access to relevant information on the provider server through the mobile device, the provided relevant information determined at least in part by the customer information; and
the customer may complete a task related to a visit to the location-based business, and information about the task is communicated from the provider server to the business server.

2. The system of claim 1 wherein the location-based business is a medical facility, the customer is a patient, and the mobile interface software provides access to electronic forms related to a doctor appointment.

3. The system of claim 1 wherein the location-based business is a restaurant and the mobile interface software provides access to an electronic menu.

4. The system of claim 3 wherein the task which may be completed by the customer comprises ordering a menu item from the restaurant.

5. The system of claim 1 wherein the location-based business is a store and the mobile interface software provides access to information related to products offered by the store.

6. The system of claim 1 wherein the location-based business welcomes the customer upon arrival at the geographic location of the location-based business through the mobile device.

7. The system of claim 1 further comprising a customer profile located on the provider server, wherein the customer may modify the customer profile.

8. The system of claim 7 wherein the customer profile comprises customer billing information.

9. The system of claim 1 wherein the mobile interface software provides the customer with information on a business rewards program for the location-based business through the mobile device.

10. The system of claim 1 wherein the task which may be completed by the customer comprises ordering a product and/or service from the location-based business.

11. The system of claim 10 wherein the customer my track the progress of the ordered product and/order service through the mobile device.

12. The system of claim 1 wherein the task which may be completed by the customer comprises filling out a form or providing information to the location-based business to assist the location-based business in serving the customer.

13. The system of claim 1 wherein the task which may be completed by the customer comprises initiating payment for a good and/or service provided by the location-based business.

14. The system of claim 13 wherein the provider server settles payment and communicates payment to the business server.

15. The system of claim 1 wherein the task which may be completed by the customer comprises alerting the location-based business to the customer's presence at the geographic location of the location-based business.

16. The system of claim 1 wherein the provider server is under the physical control of a third party provider.

17. The system of claim 1 wherein at least a portion of the business server is backed-up over the network to the provider server.

18. The system of claim 1 further comprising navigation software executing on a computer readable medium for navigating a customer to a product or service provider located at the location-based business based at least in part on an inquiry by the customer made through the mobile device or a predetermined product or service determined at least in part by the customer information.

19. The system of claim 1 wherein the authentication software further comprises asking the customer for a username/password combination and/or a biometric identifier.

20. The system of claim 1 wherein the customer information includes a customer transaction history, which is made available to the customer through the mobile device.

21. The system of claim 1 further comprising a customer service survey offered to the customer, the customer service survey relating to the customer's visit to the location-based business.

22. The system of claim 1 further comprising a kiosk whereby the customer can rent or borrow the mobile device during the customer's visit to the location-based business.

23. The system of claim 22 wherein the customer information is associated with the mobile device when the customer rents or borrows the mobile device.

24. A system for providing information and services through a mobile device to a customer of a location-based business, comprising:
a provider server having information related to products and/or services of the location-based business, the provider server accessible over a network from the location-based business;
management software executing on a computer readable medium for managing the information on the provider server by an agent of the location-based business;
authentication software executing on a computer readable medium for authenticating the mobile device based at least in part on the proximity of the mobile device to the location-based business;
mobile interface software executing on a computer readable medium for providing the information from the provider server to the customer wirelessly through the mobile device and for receiving data input from the customer through the mobile device;
administration software executing on a computer readable medium for alerting the location-based business to the customer's presence and/or providing the customer a time estimate until the customer will be helped by an agent of the location-based business and/or providing information about the customer;
education software executing on a computer readable medium for providing, through the mobile device, educational information related to the location-based business' products and/or services;
advertising software executing on a computer readable medium for providing directed advertising to the customer, through the mobile device, based at least on the type of location-based business and/or the information the customer is viewing through the mobile device;
wherein the provider server communicates over a network with a business server, the business server located at the location-based business and having information related to back-office operations of the location-based business including customer information for the customer;
when the customer is at or near the geographic location of the location-based business the customer is provided access to relevant information on the provider server through the mobile device, the provided relevant information determined at least in part by the customer information; and
the customer may complete a task related to a visit to the location-based business, and information about the task is communicated from the provider server to the business server.

25. The system of claim 24 wherein the location-based business welcomes the customer upon arrival at the geographic location of the location-based business through the mobile device.

26. The system of claim 24 further comprising a customer profile located on the provider server, wherein the customer may modify the customer profile.

27. The system of claim 26 wherein the customer profile comprises customer billing information.

28. The system of claim 24 wherein the mobile interface software provides the customer with information on a business rewards program for the location-based business through the mobile device.

29. The system of claim 24 wherein the task which may be completed by the customer comprises ordering a product and/or service from the location-based business.

30. The system of claim 29 wherein the customer my track the progress of the ordered product and/order service through the mobile device.

31. The system of claim 24 further comprising entertainment software executing on a computer readable medium for providing, through the mobile device, entertainment to the customer while the customer waits until the customer is helped by an agent of the location-based business.

32. The system of claim 24 further comprising reporting software executing on a computer readable medium for providing information on revenue generated by the advertising software.

33. The system of claim 24 wherein the authentication software further comprises asking the customer for a username/password combination or a biometric identifier.

34. The system of claim 24 wherein the advertising software comprises a paid content wrapper.

35. The system of claim 24 wherein revenue generated by the advertising software is shared at least by the customer and the location-based business.

36. The system of claim 24 wherein revenue generated by the advertising software is shared at least by the customer and a third party provider that physically controls the provider server.

37. The system of claim 24 wherein revenue generated by the advertising software is shared at least by the location-based business and a third party provider that physically controls the provider server.

38. A system for providing information and services through a mobile device to a patient of a location-based medical provider, comprising:
a provider server having information related to products and/or services of the medical provider, the provider server accessible over a network from the medical provider and under the physical control of a third party service provider;
management software executing on a computer readable medium for managing the information on the provider server by an agent of the medical provider;
uthentication software executing on a computer readable medium for authenticating the mobile device based at least in part on the proximity of the mobile device to the medical provider;
mobile interface software executing on a computer readable medium for providing the information from the provider server to the patient through the mobile device and for receiving data input from the patient wirelessly through the mobile device;
administration software executing on a computer readable medium for alerting the location-based business to the patient's presence at the geographic location of the medical provider and/or providing the patient a time estimate until the patient will be seen by the medical provider;
education software executing on a computer readable medium for providing, through the mobile device, educational information related to the patient's visit to the medical provider;
advertising software executing on a computer readable medium for providing directed advertising to the patient, through the mobile device, based at least on the type of medical provider and/or the information the patient is viewing through the mobile device and/or information about the patient;
wherein the provider server communicates over a network with a business server, the business server located at the medical provider and having information related to back-office operations of the medical provider including patient information about the patient;
when the patient is at or near the geographic location of the medical provider the patient is provided access to information on the provider server through the mobile device; and
the patient may complete a task related to a visit to the medical provider, and information about the task is communicated from the provider server to the business server.

39. The system of claim 38 wherein the administration software admits or processes the patient for a doctor appointment.

40. The system of claim 38 wherein the patient or medical provider can manage a copy of the patient's patient record stored on the provider server.

41. The system of claim 38 wherein a further medical provider can manage a copy of the patient's patient record stored on the provider server.

42. The system of claim 38 wherein the task which may be completed by the patient comprises completing a medical form for a doctor appointment.

43. The system of claim 42 wherein the data from the medical form is transmitted to the business server to automate data entry in the medical provider's system.

44. The system of claim 38 wherein the task which may be completed by the patient comprises scheduling a doctor appointment.

45. The system of claim 38 further comprising social network software executing on a computer readable medium for the patient to interact with other patients to share information.

46. The system of claim 38 further comprising social network software executing on a computer readable medium for the medical provider to interact with further medical providers to share information regarding patent care.

47. The system of claim 38 wherein the advertising software comprises a paid content wrapper.

48. The system of claim 38 wherein revenue generated by the advertising software is shared at least by the patient and the medical provider.

49. The system of claim 38 wherein revenue generated by the advertising software is shared at least by the patient and the third party service provider.

50. The system of claim 38 wherein revenue generated by the advertising software is shared at least by the medical provider and the third party service provider.

51. The system of claim 38 wherein a patient's share of revenue generated by the advertising software funds a medical savings account.

52. The system of claim 38 wherein a patient's share of revenue generated by the advertising software can be redeemed for cash, services, or products.

53. The system of claim 38 further comprising a website for the patient to access information on the provider server through a web browser from a personal computer.

54. The system of claim 38 further comprising messaging software executing on a computer readable medium for the patient to securely message the medical provider.

55. A system for providing front-office features to a back-office system of a location-based business, comprising:
a provider server having information related to the goods and/or services of the location-based business, the provider server accessible over a network from the location-based business;
management software executing on a computer readable medium for managing the information on the provider server by an agent of the medical provider;
authentication software executing on a computer readable medium for authenticating a mobile device based at least in part on the proximity of the mobile device to the medical provider;
mobile interface software executing on a computer readable medium for providing the information from the provider server to a customer of the location-based business through the mobile device and for receiving data input from the customer wirelessly through the mobile device; and
a business server having information related to back-office operations of the location-based business including customer information for the customer, the business server located at the location-based business and adapted to communicate with the provider server;
wherein the customer may complete a task related to a visit to the location-based business through the mobile device, and information about the task is communicated from the provider server to the business server.

56. The system of claim 55 wherein the mobile device communicates securely with the provider server.

57. The system of claim 55 wherein information related to the back-office operations of the location-based business is backed-up to the provider server.

58. The system of claim 55 wherein the business server is adapted for setting up secure link with the provider server.

59. The system of claim 55 wherein the mobile device communicates to the provider server using at least in part the same network as the provider server uses to communicate with the business server.

60. A method for providing front-office features to a back-office system of a location-based business, comprising:
providing a provider server having information related to the goods and/or services of the location-based business, the provider server accessible over a network from the location-based business;
providing management software executing on a computer readable medium for managing the information on the provider server by an agent of the medical provider;
providing authentication software executing on a computer readable medium for authenticating a mobile device based at least in part on the proximity of the mobile device to the medical provider;
providing mobile interface software executing on a computer readable medium for providing the information from the provider server to a customer of the location-based business through the mobile device and for receiving data input from the customer wirelessly through the mobile device; and
providing a business server having information related to back-office operations of the location-based business including customer information for the customer, the business server located at the location-based business and adapted to communicate with the provider server;
wherein the customer may complete a task related to a visit to the location-based business through the mobile device, and information about the task is communicated from the provider server to the business server.

61. The method of claim 60 wherein the mobile device communicates securely with the provider server.

62. The method of claim 60 wherein information related to the back-office operations of the location-based business is backed-up to the provider server.

63. The method of claim 60 wherein the business server is adapted for setting up a secure link with the provider server.

64. The method of claim 60 further comprising the step of providing education software executing on a computer readable medium for providing, through the mobile device, educational information related to the customer's visit to the location-based business, the education software comprising the steps of semantically illustrating anatomy, physiology, pathology, and treatment options.

65. A system for providing information and services through a mobile device to a customer of a business, comprising:
a provider server having information related to products and/or services of the business, the provider server accessible over a network;
management software executing on a computer readable medium for managing the information in the provider server by an agent of the business;
authentication software executing on a computer readable medium for authenticating the mobile device based at least in part on a username/password combination and/or a biometric identifier;
mobile interface software executing on a computer readable medium for wirelessly providing the information from the provider server to the customer through the mobile device and for receiving data input from the customer through the mobile device;
wherein the provider server communicates over a network with a business server, the business server having information related to back-office operations of the business including customer information for the customer;
the customer is provided access to information on the provider server through the mobile device, the provided relevant information determined at least in part by the customer information; and
the customer may complete a task related to a transaction with the business, and information about the task is communicated from the provider server to the business server.

66. The system of claim 65 wherein the business is a travelling medical provider.

67. The system of claim 65 wherein the business is a food delivery service.

68. A system for generating advertising revenue for a location-based business, comprising:
a provider server having information related to products and/or services of the location-based business, the provider server accessible over a network from the location-based business;
management software executing on a computer readable medium for managing the information in the provider server by an agent of the location-based business;
authentication software executing on a computer readable medium for authenticating the mobile device based at least in part on the proximity of the mobile device to the geographic location of the location-based business;
mobile interface software executing on a computer readable medium for wirelessly providing the information from the provider server to a customer of the location-based business through the mobile device and for receiving data input from the customer through the mobile device;
advertising software executing on a computer readable medium for providing directed advertising to the customer, through the mobile device, based at least on the type of location-based business and/or the information the customer is viewing through the mobile device and/or information about the customer;
wherein the provider server communicates over a network with a business server, the business server located at the location-based business and having information related to back-office operations of the location-based business including customer information for the customer;
when the customer is at or near the geographic location of the location-based business the customer is provided access to information on the provider server through the mobile device; and
the customer may complete a task related to a visit to the location-based business through the mobile device, and information about the task is communicated from the provider server to the business server.

69. The system of claim 68 wherein the advertising software comprises a paid content wrapper.

70. The system of claim 68 wherein revenue generated by the advertising software is shared at least by the customer and the location-based business.

71. The system of claim 68 wherein revenue generated by the advertising software is shared at least by the customer and a third party service provider that physically controls the provider server.

72. The system of claim 68 wherein revenue generated by the advertising software is shared at least by the location-based business and a third party service provider that physically controls the provider server.
